(19) United States
(12) Patent Application Publication
(10) Pub. No.: US 2005/0202188 A1
(43) Pub. Date: Sep. 15, 2005

(54) Image-receiving material and ink jet recording method

(75) Inventors: Toshiaki Aono, Shizuoka-ken (JP); Hiroshi Kawakami, Shizuoka-ken (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 11/074,996

(22) Filed: Mar. 9, 2005

(30) Foreign Application Priority Data
Mar. 9, 2004 (JP) 2004-065956

(51) Int. Cl. B41M 5/00

(52) U.S. Cl. 428/32.34

(57) ABSTRACT

The present invention provides an image-receiving material having a support and an ink-receiving layer formed on the support, wherein the ink-receiving layer contains at least one of the groups consisting of: particles having penetration holes; and particles having concaves, in an amount of at least 10 mass % based on the total solid content of the ink-receiving layer. The ink-receiving layer has thermoplasticity, and the ink-receiving layer contains a thermoplastic component which generates the thermoplasticity, in an amount of at least 50 mass % based on the total solid content of the ink-receiving layer. The invention also provides an ink jet recording method which includes subjecting the image-receiving material after recording to smoothing treatment.

### CROSS-REFERENCE TO RELATED APPLICATION

This application claims priority under 35 USC 119 from Japanese Patent Application No. 2004-65956, the disclosure of which is incorporated by reference herein.

### BACKGROUND OF THE INVENTION

1. Field of the Invention

The present invention relates to an image-receiving material for ink jet printing and the like and to a method for ink jet recording.

2. Description of the Related Art

Various characteristics are demanded of image-receiving materials for ink jet printing; such as ability to form images with high chroma saturation thereon, ability of dyes to be firmly fixed to the image-receiving materials for ink jet printing, and ability of the materials to dry quickly so as not to cause bleeding of ink. In the way of image-receiving materials for ink jet printing to respond to such demands, materials that are produced by applying a liquid containing inorganic particles and water-soluble resins such as polyvinyl alcohol and gelatin on a support to form a porous layer (an ink-receiving layer) (see Japanese Patent Application Laid-Open No. 10-119423, for example) and the like are conventionally known.

Regarding ink for ink jet printing, various kinds of ink such as water-soluble dye ink, pigment ink, dispersion ink, UV ink, and solvent ink are known. In practical use, water-soluble ink is mainly used, with pigment ink also being used in some applications. Pigment ink is superior in water resistance and light resistance compared to water-soluble dye ink. However, when pigment ink is printed on an image-receiving material intended for ink jet printing having the aforementioned ink-receiving layer, the ink does not penetrate sufficiently into the ink-receiving layer and the resulting images are poor in chafing resistance and glossiness.

As a solution to this problem, a recording method is known in which an aqueous ink containing a pigment (carbon black) having a small primary particle diameter, a low structure, and a specific binder (a macromolecule having an amide bond and/or a urethane bond) is used. In this method, printing is applied to a specific ink jet printing sheet, that is, one in which a porous layer is disposed on a support, the layer having, pores with an average diameter of 1 μm or less and being formed by applying a liquid wherein inorganic particles are dispersed by a binder resin (see claims 1 and 6 of JP-A No. 2002-97390). The reason given for the average pore diameter being up to 1 μm is that if the diameter is greater than that, carbon black dispersion particles in the ink penetrate the porous layer and fail to remain on the recording sheet, leading to insufficient print density.

One of the technical objectives of image recording is the increase of recording speed. Similarly, high speed is also demanded of ink jet printing, especially, high speed printing using a line head.

However, since ink-receiving layers in conventional image-receiving materials used for ink jet printing have relatively small average pore diameters (for example, 0.03 μm in the recording sheet (specially designed glossy film B) as disclosed in Table 7 in paragraph 0085 of JP-A 2002-97390), water-soluble ink, pigment ink, dispersion ink, UV ink, and solvent inks, which have been developed widely for ink jet printing, are not necessarily able to form images with sufficient quality. Specifically, when a dispersion ink for ink jet printing (that is namely, an ink comprising dispersed colored particles obtained by enclosing an oil-soluble dye in oil-soluble polymer particles) is printed to the aforementioned ink jet-use image-receiving material, the dispersion ink displays extremely poor penetration and lacks in quick drying. It is therefore currently impossible to use dispersion ink for high speed printing.

A recording sheet which is adapted to high-speed ink jet printing and prevents ink from blurring or bleeding is proposed in JP-A No. 2000-190630. This recording sheet is composed of inorganic particles and polyolefin resin, and at least 80% of a void capacity thereof is accounted for in pores having a pore diameter of 1 μm or less, in other words, pores having a diameter larger than 1 μm are substantially eliminated from the sheet (see paragraph 0007).

However, the method for producing this recording sheet has many problems since it requires mixing a plasticizer with the inorganic particles and the polyolefin resin, shaping the mixture into sheet form while heat-melting and kneading the mixture, and thereafter removing the plasticizer by extraction using an organic solvent. Further, the porous film produced with the above-mentioned method is highly hydrophobic and therefore is insufficient in terms of absorbability of aqueous ink.

JP-A No. 2000-238408 discloses an image-receiving material used in ink jet printing produced by applying a liquid to form an image-receiving layer containing particles having a positive charge, particles having a negative charge, and an aqueous binder on a support. The liquid is then dried to form an image-receiving layer having a porous structure. The image-receiving layer is superior in strength, has a high porosity, and contains uniform pores. Therefore, it possesses high ink absorbability and is superior in dye fixability.

Ink jet-use the image-receiving material is, however, basically intended for use with water-soluble dye ink, and a average pore diameter of which is 0.1 μm or less.

JP-A No. 7-1835 describes an ink jet recording sheet containing porous resin particles. By incorporation of the porous resin particles, the ink jet recording sheet can be made excellent in water absorbability and also oil absorbability to cope with a high-resolution and high-speed ink jet system. However, although this ink jet recording sheet is excellent in water absorption for document printing on high-quality paper, there is a problem of insufficient performance in the case where a support which does not absorb water due to the material having no water absorbability is used therein (such as kaolin clay or the like). Further, this ink jet recording sheet cannot provide an image that is sufficiently excellent in glossiness even if it is subjected to smoothing treatment by heating.

### SUMMARY OF THE INVENTION

The present invention was made based on the demand described above. The invention provides an image-receiving material excellent in permeability even when dispersed ink is applied thereto, that is capable of being applied to high-speed printing with a line head, and that is capable of forming an image excellent in glossiness due to smoothing treatment by heating, as well as an ink jet recording method using the image-receiving material.

That is, the invention provides an image-receiving material having a support and an ink-receiving layer formed on the support, wherein the ink-receiving layer contains at least one of the groups consisting of: particles having penetration holes; and particles having concaves, in an amount of at least 10 mass % based on the total solid content of the ink-receiving layer, the ink-receiving layer has thermoplasticity, and the ink-receiving layer contains a thermoplastic component which generates the thermoplasticity, in an amount of at least 50 mass % based on the total solid content of the ink-receiving layer.

Further, the invention provides an ink jet recording method including recording on the image-receiving material with at least one of dispersed ink, pigment ink, water-soluble dye ink, photo-curable ink and solvent ink, and subjecting the image-receiving material after recording to smoothing treatment.

### BRIEF DESCRIPTION OF THE DRAWINGS

Preferable embodiments of the present invention will be described in detail based on the following figures.

FIG. 1 shows one example of a heating roll used in smoothing treatment in the image formation method of the invention.

FIG. 2 shows one example of a heating belt and a press roll used in smoothing treatment in the image formation method of the invention.

### DETAILED DESCRIPTION OF THE INVENTION

The image-receiving material of the present invention has a support and an ink-receiving layer formed on the support, wherein the ink-receiving layer contains at least one of the group consisting of: particles having penetration holes (referred to hereinafter as “penetration hole particles”); and particles having concaves, in an amount of at least 10 mass % based on the total solid content of the ink-receiving layer. The ink-receiving layer has thermoplasticity, and the ink-receiving layer contains a thermoplastic component which generates the thermoplasticity, in an amount of at least 50 mass % based on the total solid content of the ink-receiving layer.

In the image-receiving material of the invention, the ink-receiving layer contains penetration hole particles and/or particles having concaves, and a permeability of the ink-receiving layer with ink can be improved by the particles. The ink-receiving layer has thermoplasticity and the content of a thermoplastic component generating the thermoplasticity is 50 mass % or more based on the total solid content of the ink-receiving layer, whereby an image rendered excellent in glossiness by smoothing treatment can be formed.

Ink-Receiving Layer

Penetration Hole Particles

The penetration hole particle is a particle having penetration holes from a certain face (area) to another face (area) of the particle. The ink-receiving layer is formed accompanied by incorporation of penetration hole particles, whereby ink can be absorbed (accommodated) not only into the space between the particles but also into the penetration holes. Thus the ink absorbability of the ink-receiving layer as a whole can be improved.

The surface of the penetration hole particle is partially hydrophobic or hydrophilic and it is thus guessed to be excellent in permeability with solvent ink and UV ink. By rendering the surface hydrophilic with a surfactant (including polymers) having hydrophobic regions and hydrophilic regions, it is expected that the affinity thereof for water-soluble dye ink, pigment ink, and dispersed ink will also increase to improve water absorbability (ink permeability).

Examples of the surfactant for hydrophilization of the surface of the penetration particle include surfactants described in the following specifications or publications: U.S. Pat. No. 2,240,469, U.S. Pat. No. 2,240,470, U.S. Pat. No. 2,240,471, U.S. Pat. No. 2,240,472, U.S. Pat. No. 2,240,475, U.S. Pat. No. 2,240,476, U.S. Pat. No. 2,253,279, U.S. Pat. No. 2,719,087, U.S. Pat. No. 2,739,891, U.S. Pat. No. 2,801,191, U.S. Pat. No. 2,813,123, U.S. Pat. No. 2,843,487, U.S. Pat. No. 3,003,877, U.S. Pat. No. 3,026,202, U.S. Pat. No. 3,038,804, U.S. Pat. No. 3,041,171, U.S. Pat. No. 3,038,804, U.S. Pat. No. 3,068,101, U.S. Pat. No. 3,165,409, U.S. Pat. No. 3,169,870, U.S. Pat. No. 3,201,252, U.S. Pat. No. 3,220,847, U.S. Pat. No. 3,306,749, U.S. Pat. No. 3,408,193, U.S. Pat. No. 3,425,857, U.S. Pat. No. 3,437,485, U.S. Pat. No. 3,502,473, U.S. Pat. No. 3,506,449, U.S. Pat. No. 3,514,293, U.S. Pat. No. 3,539,352, U.S. Pat. No. 564,576, U.S. Pat. No. 3,573,049, U.S. Pat. No. 3,607,291, U.S. Pat. No. 3,775,126, U.S. Pat. No. 3,850,640, U.S. Pat. No. 3,909,272, U.S. Pat. No. 887,012, U.S. patent application Ser. Nos. 230519, 442794, 480101, 515179 and 580872, U.K. Patent Nos. 774806, 867842, 874081 and 1186866, Japanese Patent Application Publication (JP-B) No. 43-10247, JP-B No. 43-13481, JP-B No. 43-24722, JP-B No. 44-22659, JP-B No. 45-38945, JP-B No. 46-21985, JP-B No. 49-16051, JP-A No. 48-43924, JP-A No. 49-37623, JP-A No. 50-46133, JP-A No. 51-7917, JP-A No. 53-21922, JP-A No. 53-49427, JP-A No. 54-98235, JP-A No. 51-3219, JP-B No. 39-18702, JP-B No. 40-376, JP-B No. 40-1701, JP-B No. 40-23747, JP-B No. 43-13166, JP-B No. 43-17922, JP-B No. 44-22661, JP-B No. 45-3830, JP-B No. 45-334767, JP-B No. 46-21183, JP-B No. 46-25954, JP-B No. 46-31191, JP-B No. 46-43428, JP-B No. 47-4639, JP-B No. 47-5318, JP-B No. 47-15801, Japanese Patent Application No. 42-58329, U.K. Patent Nos. 1039183, 1178546, 1301828, 1320880, 1336164, 1336172, 1344987 and 1345533, West German Patent Nos. 1171738 and 1186743, Belgian Patent Nos. 609782 and 543287, U.S. Pat. No. 3,042,222, U.S. Pat. No. 3,113,816, U.S. Pat. No. 3,442,654, U.S. Pat. No. 3,516,835, U.S. Pat. No. 3,563,756, U.S. Pat. No. 3,617,292, U.S. Pat. No. 3,619,199, U.S. Pat. No. 3,725,079, U.S. Pat. No. 3,725,680, U.S. patent application Ser. Nos. 505453 and 579213, U.S. Pat. No. 3,493,379, U.S. Pat. No. 3,416,923, U.S. Pat. No. 3,542,581, U.S. Pat. No. 3,619,195, U.S. Pat. No. 3963688, JP-A No. 47-23378, JP-A No. 48-9979, JP-A No. 48-30933, JP-A No. 50-66230, JP-A No. 50-80119, JP-A No. 51-25133, JP-A No. 53-138726, JP-A No. 50-34233, JP-A No. 41-72675,

U.K. Patent Nos. 1346425, 1346426 and 1498697, West Germany Patent Nos. 1772129, 2049689, 1201136 and 1597492, U.S. Pat. No. 3,565,625, U.S. Pat. No. 3,679,411, U.S. Pat. No. 2,848,330, U.S. Pat. No. 2,940,851, U.S. Pat. No. 2,944,900, U.S. Pat. No. 2,944,902, U.S. Pat. No. 3,017,271, U.S. Pat. No. 3,061,437, U.S. Pat. No. 3,062,647, U.S. Pat. No. 3,068,102, U.S. Pat. No. 3,128,183, U.S. Pat. No. 3,434,833, U.S. Pat. No. 3,523,023, U.S. Pat. No. 3,706,562, U.S. Pat. No. 3,869,289, JP-B No. 49-33788, JP-B No. 53-12380, JP-B No. 53-15831, Belgian Patent No. 611864, West Germany Patent Nos. 1151437, 1472790, 1772315, 1816570, 1816572 and 2845907, U.K. Patent Nos. 1351498, 1326358, 1455413, 1463659, 1488991, 1212312, 3084044, 3113026 and 2937087, JP-A No. 47-42001, JP-A No. 49-55335, JP-A No. 50-156423, JP-A No. 53-44025, JP-A No. 49-24427,

U.K. Patent No. 1491902, JP-A No. 48-23436, JP-A No. 48-63735, JP-A No. 48-94433, JP-A No. 50-57437, U.S. Pat. No. 3,062,654, U.S. Pat. No. 3,093,479, U.S. Pat. No. 3,396,028, U.S. Pat. No. 3,743,504, Research Disclosure No. 17643 (December, 1978), JP-B No. 45-6629, JP-B No. 47-41833, JP-B No. 49-4530, JP-B No. 54-15751, JP-B No. 54-17832, JP-B No. 54-89624, JP-B No. 45-6630, JP-B No. 47-4417, JP-B No. 47-15801, JP-B No. 48-34166, JP-B No. 50-40660, JP-B No. 51-848, West German Patent Nos. 1202136, 1447585, 1472274, 2641284 and 22031116, Belgian Patent Nos. 605378, 622859, 631905 and 631557, U.K. Patent Nos. 1327032 and 1358848, U.S. Pat. No. 3,597,214, U.S. Pat. No. 3,615,612, U.S. Pat. No. 3,493,379, U.S. Pat. No. 3,798,265, Research Disclosure No. 11666 (December, 1973), U.S. Pat. No. 3,705,806, JP-A No. 55-59464, JP-A No. 50-113221, JP-A No. 55-22754, JP-A No. 55-79435, JP-A No. 54-81829, JP-A No. 57-85047, JP-A No. 57-104925, JP-A No. 58-86540, JP-A No. 58-90633, JP-A No. 56-81841, JP-A No. 53-138726, European Patent Nos. 19800 and 153133, JP-A No. 60-203935, JP-A No. 60-200251 and JP-A No. 60-209732.

Preferable compounds are illustrated below. 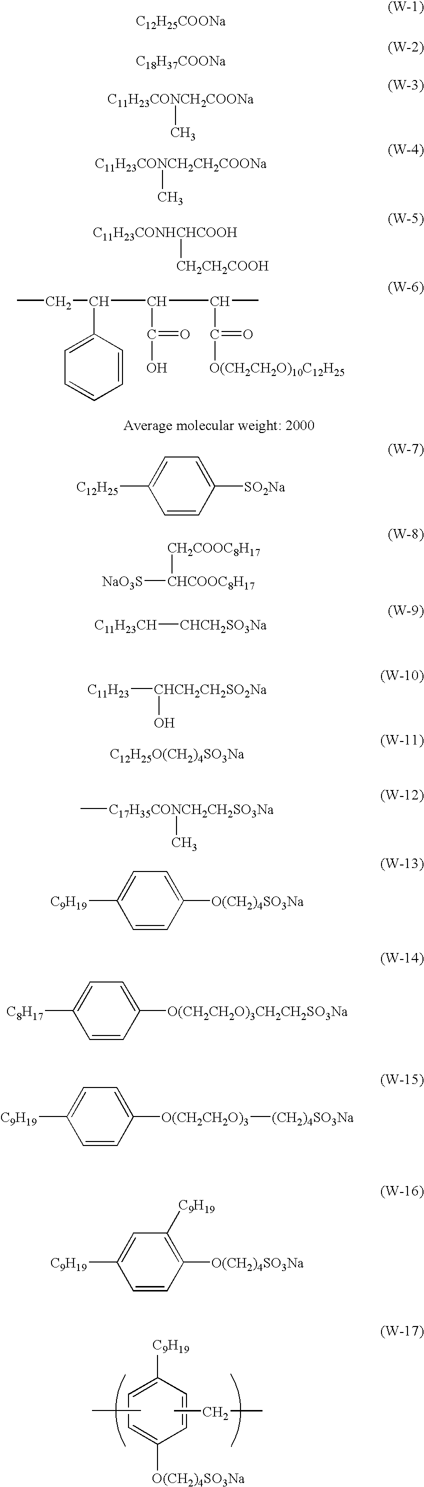 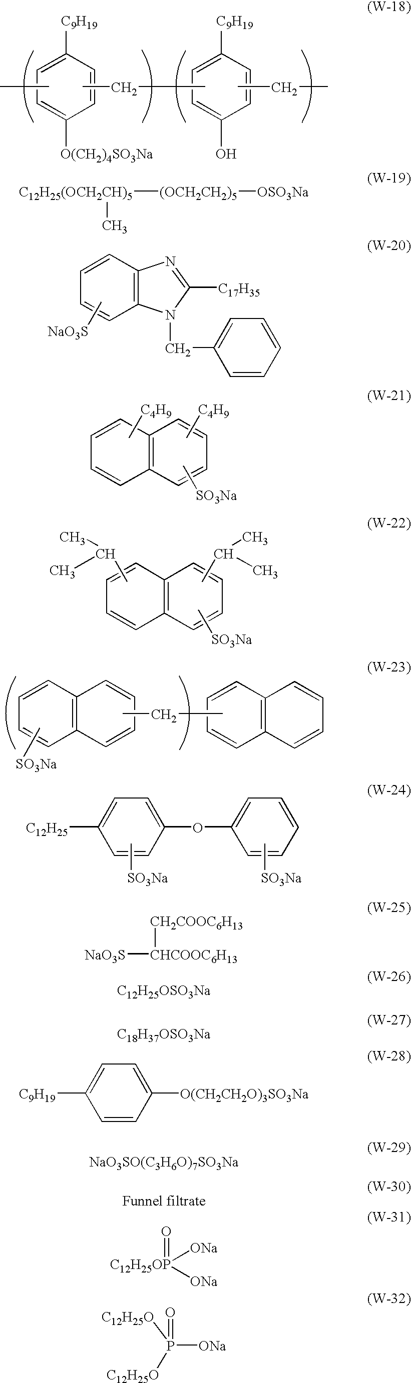 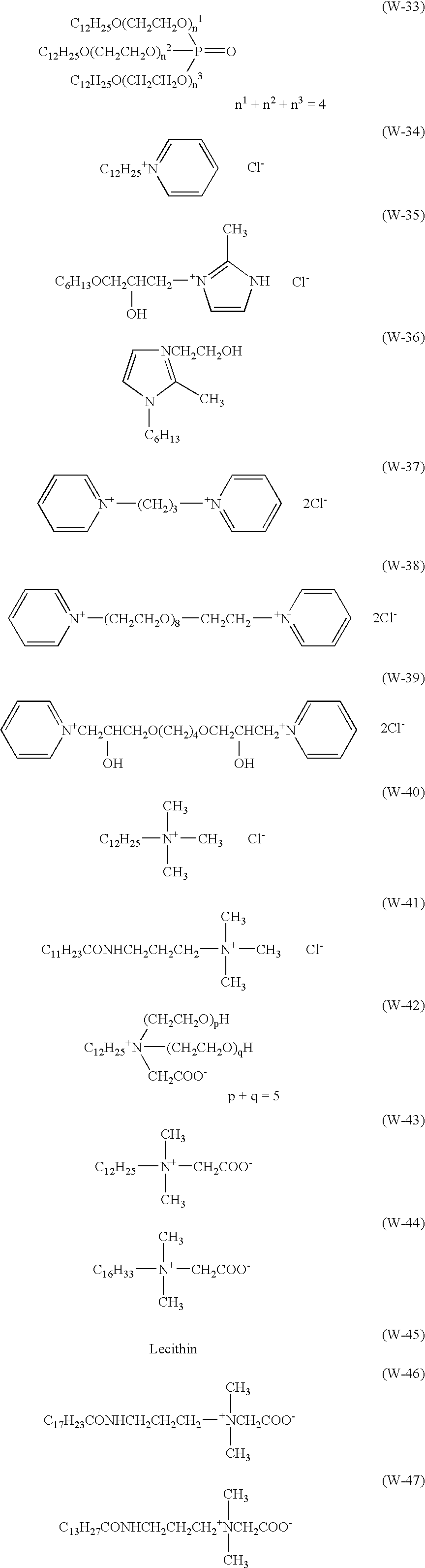 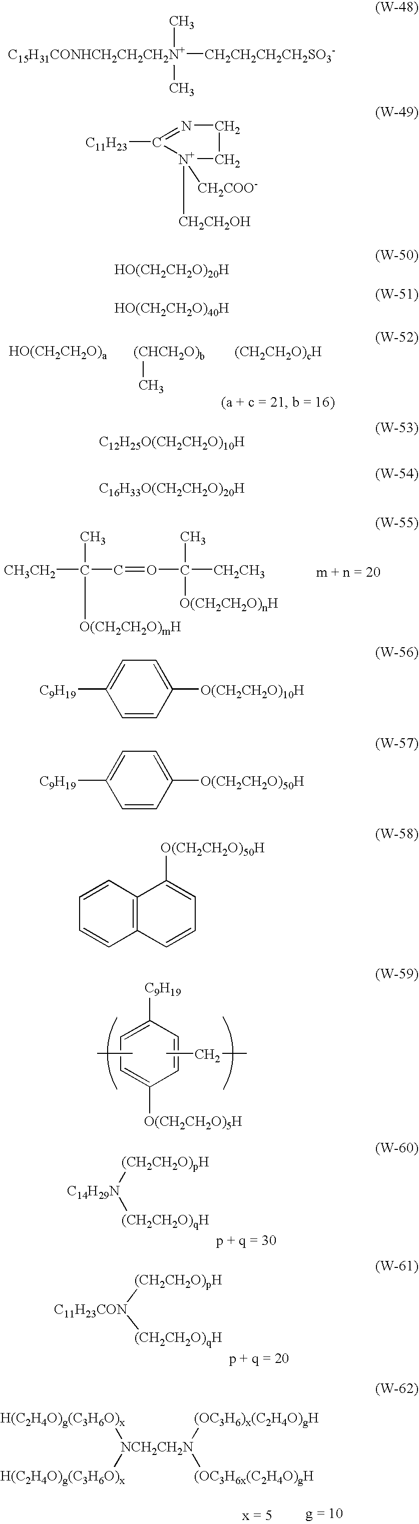
(W-63) Sorbitan ester span 80
(W-64) Sorbitan ester span 60
(W-65) Sorbitan ester span 40
(W-66) Polyoxyethylene sorbitan monolaurate (n=20)
(W-67) Polyoxyethylene sorbitan monooleate (n=15)
(W-68) Polyoxyethylene sorbitan tristearate (n=30)

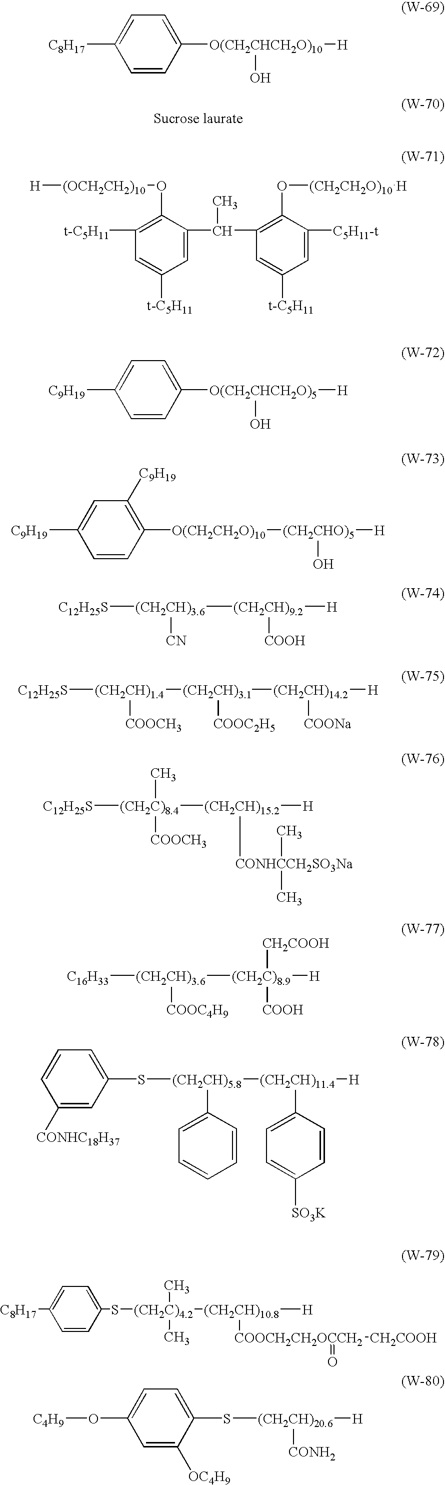

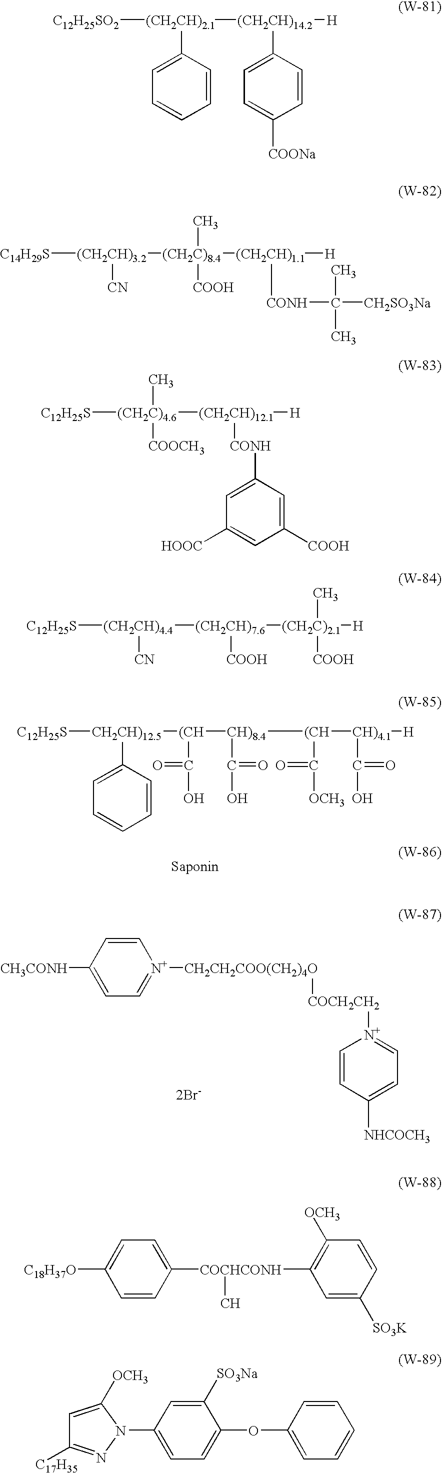

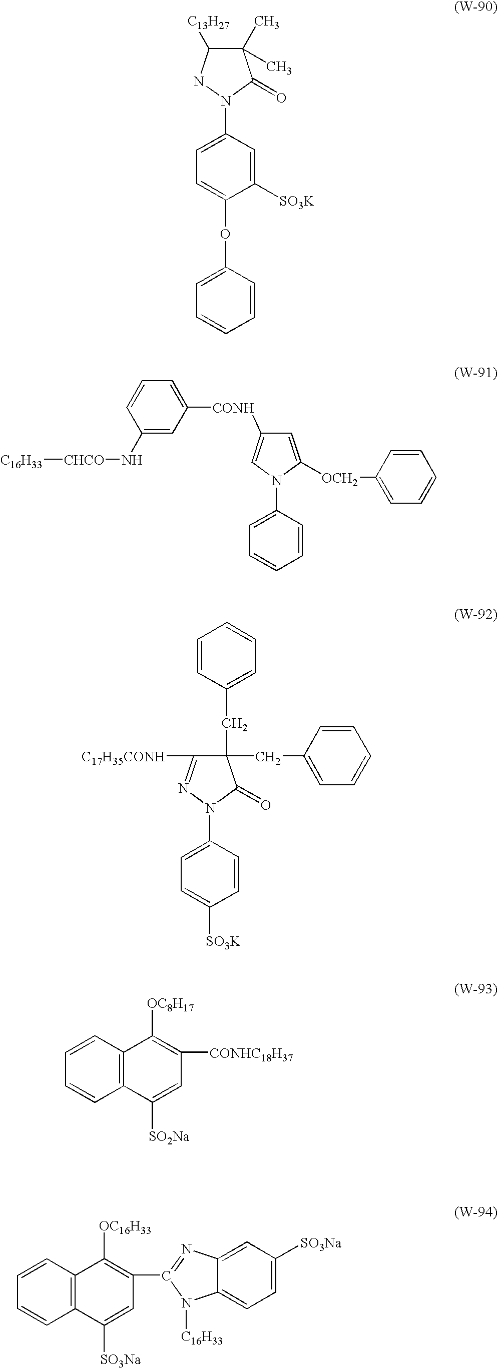

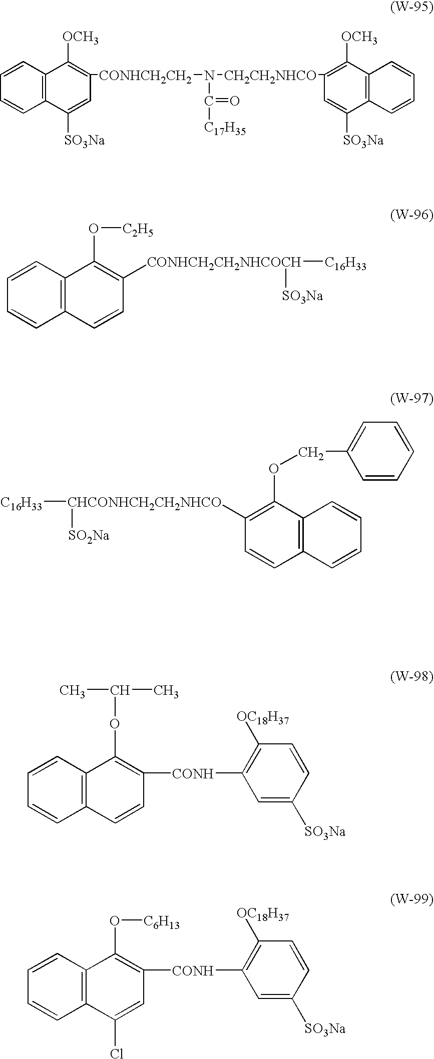

The volume-average particle diameter (median diameter) of the penetration hole particles is preferably 0.1 to 10 μm, more preferably 0.2 to 7 μm. The volume-average particle diameter of the penetration hole particles is a numerical value determined by a laser diffraction/scattering particle diameter measuring instrument (trade name: LA-910, manufactured by Horiba Ltd.).

The diameter of the penetration hole is preferably 1/100 to ½, more preferably 1/50 to ⅓, relative to the particle diameter. The void ratio of the penetration hole particle is preferably 10% or more, more preferably 20 to 70%.

Specifically, the penetration hole particles are preferably organic particles, the organic particles being made preferably of styrene compounds or acrylic compounds. Specific examples include MUTICLE PP-2000TX (trade name, styrene/acrylic compound manufactured by Mitsui Chemicals, Inc.).

The penetration hole particles can be produced by a method described in, for example, JP-A No. 5-222108.

Particles Having Concaves

The particles having concaves are particles having concaves at least in a portion thereof, and examples include erythrocyte-shaped flat particles (hereinafter referred to as “erythrocyte-shaped particles”) and golf ball-shaped particles, of which the erythrocyte-shaped particles are preferable. The erythrocyte-shaped particles have concaves on flattened spheres, and are for example in the shape of human erythrocytes. With the particles having concaves, similar to the penetration hole particles, ink can be absorbed (accommodated) not only into the space between the particles but also into the concaves, and thus the ink absorbability of the ink-receiving layer as a whole can be improved.

The diameter of the particles having concaves is preferably 0.1 to 10 μm, more preferably 0.2 to 7 μm. The diameter of the particles having concaves is a numerical value determined by a laser diffraction/scattering particle diameter measuring instrument (trade name: LA-910, manufactured by Horiba Ltd.).

Specific examples of the erythrocyte-shaped particles used as particles having concaves include MUTICLE PP240D (trade name, styrene compound manufactured by Mitsui Chemicals, Inc.).

The content of the penetration hole particles or the particles having concaves is preferably 10 to 95 mass %, more preferably 20 to 90 mass %, still more preferably 30 to 85 mass %, based on the total solid content of the ink-receiving layer. When the content of the particles is lower than 10 mass %, liquid absorbability cannot be achieved.

When the penetration hole particles and the particles having concaves are used simultaneously, the content ratio thereof can be established arbitrarily.

Thermoplastic Fine Particle

Preferably, the ink-receiving layer contains not only the penetration hole particles or particles having concaves but also thermoplastic fine particles. The thermoplastic fine particles function as a binder.

The thermoplastic fine particles are selected suitably from water-dispersible resins such as water-dispersible acrylic resin, water-dispersible polyester resin, water-dispersible polystyrene resin, and water-dispersible urethane resin; emulsions such as acrylic resin emulsion, polyvinyl acetate emulsion, and SBR (styrene/butadiene rubber) emulsion, resins or emulsions having the “thermoplastic resin” as discussed further below dispersed in water, and copolymers or mixtures thereof and cation-modified compounds thereof. Use can be made of a combination of two or more thereof. Commercial products of water-dispersible resin include, for example, BIRONAL MD-1200, MD-1220, MD-1930 (trade names, manufactured by Toyobo Co., Ltd.), PLUSCOAT Z-446, Z-465, RZ-96 (trade names, manufactured by Gooh Kagaku), ES-611, ES-670 (manufactured by Dainippon Ink and Chemicals, Incorporated), PESRESIN A-160P, A-210, A-620 (trade names, manufactured by Takamatsu Oil & Fat Co., Ltd.), HIGHLOS XE-18, XE-35, XE-48, XE-60, XE-62 (trade names, manufactured by Seiko Kagaku Kogyo) and JULIMER AT-210, AT-510, AT-515, AT-613, ET-410, ET-530, ET-533, FC-60, FC-80 (trade names, manufactured by Nihon Junyaku Co., Ltd.).

Hereinafter, examples of the thermoplastic resin refered to above are given.

(1) Thermoplastic resin having an ester bond

Examples include polyester resin obtained by condensing dicarboxylic acid components such as a terephthalic acid, an isophthalic acid, a maleic aid, a fumaric acid, a phthalic acid, an adipic acid, a sebacic acid, an azelaic acid, an abietic acid, a succinic acid, a trimellitic acid, and a pyromellitic acid (these dicarboxylic acid components may be substituted with a sulfonic acid group, a carboxyl group, and the like.) with alcohol components such as an ethylene glycol, a diethylene glycol, a propylene glycol, a bisphenol A, a diether compound of a bisphenol A (for example, a bisphenol A to which two ethylene oxide molecules were added, a bisphenol A to which two propylene oxide molecules were added, and the like), a bisphenol S, a 2-ethylcyclohexyl dimethanol, a neopentyl glycol, a cyclohexyl dimethanol, and a glycerin (these alcohol components may be substituted with a hydroxyl group or the like), polyacrylate resin, or polymethacrylate resin such as a polymethyl methacrylate, a polybutyl methacrylate, a polymethyl acrylate and a polybutyl acrylate, a polycarbonate resin, a polyvinyl acetate resin, a styrene acrylate resin, a styrene/methacrylate copolymer resin, a vinyl toluene acrylate resin, or the like.

Specifically, compounds described in JP-A No. 59-101395, JP-A No. 63-7971, JP-A No. 63-7972, JP-A No. 63-7973, and 60-294862 can be mentioned. Further, examples of commercial polyester resins include: PYRON 290, PYRON 200, PYRON 280, PYRON 300, PYRON 103, PYRON GK-140, and PYRON GK-130 (trade names, manufactured by Toyobo Co., Ltd.), TOUGHTON NE-382, TOUGHTON U-5, ATR-2009, and ATR-2010 (trade names, manufactured by Kao Corporation); ERITEL UE3500, UE3210, and XA-8153 (trade names, manufactured by Unitika); POLYESTER TP-220, and R-188 (trade names, manufactured by The Nippon Synthetic Chemical Industry Co., Ltd.); and the like. Examples of commercial products of acrylic resin that can be used include: DAIYANAL SE-5437, SE-5102, SE-5377, SE-5649, SE-5466, SE-5482, HR-169, 124, HR-1127, HR-116, HR-113, HR-148, HR-131, HR-470, HR-634, HR-606, HR-607, LR-1065, 574, 143, 396, 637, 162, 469, 216, BR-50, BR-52, BR-60, BR-64, BR-73, BR-75, BR-77, BR-79, BR-80, BR-83, BR-85, BR-87, BR-88, BR-90, BR-93, BR-95, BR-100, BR-101, BR-102, BR-105, BR-106, BR-107, BR-108, BR-112, BR-113, BR-115, BR-116, and BR-117 (trade names, manufactured by Mitsubishi Rayon Co., Ltd.); ESREK P, SE-0020, SE-0040, SE-0070, SE-0100, SE-1010, SE-1035 (trade names, manufactured by Sekisui Chemical Co., Ltd.); HIGHMER ST95 and ST120 (trade names, manufactured by Sanyo Chemical Industries, Ltd.); FM601 (trade name, manufactured by Mitsui Chemicals, Inc.), and the like.

(2) Polyurethane resin

(3) Polyamide resin, urea resin, and the like

(4) Polysulfone resin

(5) Polyvinyl chloride resin, polyvinylidene chloride resin, copolymer resin of vinyl chloride and vinyl acetate, copolymer resin of vinyl chloride and vinyl propionate, and the like (6) Polyol resin such as polyvinyl butyral and cellulose resin such as ethyl cellulose resin and acetate cellulose resin, including commercial products manufactured by Denki Kagaku Kogyo Kabushiki Kaisha, Sekisui Chemical Co., Ltd., etc. The polyvinyl butyral used in the invention is preferably one wherein the content of polyvinyl butyral is 70 mass % or more and the average polymerization degree is 500 or more, more preferably 1000 or more. Commercial products include DENKA BUTYRAL 3000-1, 4000-2, 5000A, 6000C (trade names, manufactured by Denki Kagaku Kogyo Kabushiki Kaisha) and ESREK BL-1, BL-2, BL-3, BL-S, BX-L, BM-1, BM-2, BM-5, BM-S, BH-3, BX-1, BX-7 (trade names, manufactured by Sekisui Chemical Co., Ltd.), etc.

(7) Polycaprolactone resin, styrene/maleic anhydride resin, polyacrylonitrile resin, polyether resin, epoxy resin, phenol resin, etc.

(8) Polyolefin resin such as polyethylene resin and polypropylene resin, copolymers of olefin such as ethylene or propylene and another vinyl monomer, etc.

Any of the above-mentioned (1) to (8) can be used. As thermoplastic resin, those satisfying physical properties etc. described in JP-B No. 5-127413, JP-B No. 8-194394, JP-B No. 8-334915, JP-B No. 8-334916, JP-B No. 9-171265, JP-B No. 10-221877, etc., can be preferably used.

The content of the thermoplastic fine particles is preferably 10 to 90 mass %, more preferably 20 to 80 mass %, still more preferably 30 to 70 mass %, based on the total solid content of the ink-receiving layer.

Thermoplastic Water-Soluble Polymer

Examples of water-soluble groups of the water-soluble polymer include a sulfonic acid (sulfonate) group, a sulfinic acid (sulfinate) group, a hydroxyl group, a carboxylic acid (carboxylate) group, an amino group, an ammonium group, an amide group, an ether group (including an ethylene oxide group and propylene oxide group) etc.

The water-soluble polymer includes, for example, those described on page 26 in Research Disclosure No. 17,643, on page 651 in Research Disclosure No. 18,716, on pages 873 to 874 in Research Disclosure No. 307,105, and on pages 71 to 75 of JP-A No. 64-13546. Specific examples include polyvinyl alcohol compound resin [polyvinyl alcohol (PVA), acetoacetyl-modified polyvinyl alcohol, cation-modified polyvinyl alcohol, anion-modified polyvinyl alcohol, silanol-modified polyvinyl alcohol, polyvinyl acetal etc.], ether linkage-containing resin [polyethylene oxide (PEO), polypropylene oxide (PPO), polyethylene glycol (PEG), polyvinyl ether (PVE) etc.], carbamoyl-containing resin [polyacrylamide (PAAM), polyvinyl pyrrolidone (PVP), polyacrylic acid hydrazide etc.], vinyl pyrrolidone/vinyl acetate copolymer, styrene/vinyl pyrrolidone copolymer, styrene/maleic anhydride copolymer, water-soluble polyester, water-soluble polyurethane, water-soluble nylon, water-soluble epoxy resin and alkylene oxide compound resin.

The penetration hole particles and the particles having concaves are preferably those of thermoplastic polymer. When the penetration hole particles and the particles having concaves are not of thermoplastic polymer, they may be used in combination with thermoplastic fine particles or thermoplastic water-soluble polymer. In which case, the amount of particles of thermoplastic polymer is preferably ⅓ to 3 parts by mass based on the penetration hole particles and the particles having concaves.

The ink-receiving layer of the image-receiving material of the invention has thermoplasticity, and the content of a thermoplastic component generating such thermoplasticity is 50 mass % or more based on the total solid content of the ink-receiving layer. The term “thermoplasticity” in the invention means a property by which a substance is softened and easily deformed at a temperature higher than a certain temperature. By endowing the ink-receiving layer with thermoplasticity, a printed surface after printing can be easily subjected to smoothing treatment, and by this smoothing treatment, the gloss of the image can be significantly improved. When the content of the thermoplastic component is lower than 50 mass %, the ink-receiving layer cannot be endowed with sufficient thermoplasticity.

The content of the thermoplastic component is preferably 60 mass % or more, more preferably 70 mass % or more.

Specifically, the thermoplastic component is preferably at least one member selected from organic particles, thermoplastic fine particles and thermoplastic water-soluble polymers in the case where the particles having penetration holes and the particles having concaves are organic particles, and at least one member can be used to endow the ink-receiving layer with thermoplasticity. Preferably, at least one member selected from the organic particles, thermoplastic fine particles and thermoplastic water-soluble polymers has a glass transition temperature (Tg) of 150° C. or less. Specifically, the Tg of substance existing in 50 mass % or more in the thermoplastic substance is 25 to 150° C., preferably 40 to 130° C., and more preferably 50 to 100° C.

By establishing the Tg in the range of 25 to 150° C., voids can be maintained during coating, drying, storage, etc. and liquid absorbability can be increased. Reduction in the void ratio of the image-receiving material during storage and occurrence of a breakdown due to blocking can be prevented. Also, the ink-receiving layer can be strengthened, and smoothing treatment after printing can be easily carried out to good effect.

The ink-receiving layer in the invention is preferably a porous layer, and the average pore diameter of the porous layer is 0.1 μm or more, preferably 0.3 μm or more, and more preferably 1 to 10 μm. The thickness of the ink-receiving layer is preferably about 1 to 100 μm, preferably 5 to 90 μm, and more preferably about 10 to 80 μm.

The “average pore diameter” in the invention is determined with method of mercury penetration proposed by Washburn et al. (“Hyomen” (Surface), Vol. 13, Tenth Issue, p. 588, “Theory, Apparatus and Problems of Methods for Measuring Size Distribution of Porous Material” (No. 1), written by Kohei Urano). A mercury porosimeter (trade name: PORESIZER 9320-PC2, manufactured by Shimadzu Corporation) is used as the measuring apparatus.

When the porous layer in the invention is formed on a paper support or the like by coating and cannot accurately be measured with method of mercury penetration, the average (number-average) particle diameter is determined by taking photographs of the surface of the image-receiving material at varying magnifications with a scanning electron microscope, digitizing the photographs with a scanner input method, and determining the distribution of the diameters of circles equal in area to the respective voids extracted by image analysis with a computer, after which the average particle diameter is calculated on the basis of the distribution.

Other Additives

A water-soluble binder, a mordant, fine particles, a crosslinking agent etc. added to ink-receiving layers of known ink jet recording image-receiving materials can be added if necessary to the ink-receiving layer and/or a layer adjacent thereto.

Water-Soluble Binder

The water-soluble binder includes, for example, resin having a hydroxy group in its hydrophilic structural unit, in addition to the thermoplastic water-soluble polymer described above. Mention is made of cellulose compound resin [methyl cellulose (MC)], ethyl cellulose (EC), hydroxyethyl cellulose (HEC), carboxymethyl cellulose (CMC), hydroxypropyl cellulose (HPC), hydroxyethyl methyl cellulose, hydroxypropyl methyl cellulose etc.], chitin compounds, chitosan compounds, starch, etc.

Fine Particles

In addition to the penetration hole particles, the particles having concaves, and the thermoplastic fine particles, other organic and inorganic fine particles can be used. Organic fine particles include, for example, organic fine particles having crosslinking groups introduced into them, which are obtained by emulsion polymerization, polymerization in a microemulsion system, soap-free polymerization, seed polymerization, dispersion polymerization or suspension polymerization, and fine particles such as powder of naturally occurring polymers or the like.

Inorganic fine particles include those of, for example, silica, colloidal silica, titanium dioxide, barium sulfate, calcium silicate, zeolite, kaolinite, halloysite, mica, talc, calcium carbonate, magnesium carbonate, calcium sulfate, pseudo-boehmite, zinc oxide, zinc hydroxide, alumina, aluminum silicate, calcium silicate, magnesium silicate, zirconium oxide, zirconium hydroxide, cerium oxide, lanthanum oxide and yttrium oxide.

Crosslinking Agent

When the water-soluble resin is polyvinyl alcohol, a boron compound is preferably used as a crosslinking agent. The boron compound includes, for example, borax, boric acid, borate (for example, orthoborate, InBO₃, ScBO₃, YBO₃, LaBO₃, Mg₃(BO₃)₂, Co₃(BO₃)₂, diborate (for example, Mg₂B₂O₅, Co₂B₂O₅), metaborate (for example, LiBO₂, Ca(BO₂)₂, NaBO₂, KBO₂), tetraborate (for example, Na₂B₄O₇.10H₂O), pentaborate (for example, KB₅O₈.4H₂O, Ca₂B₆O₁₁.7H₂O, CsB₅O₅) etc. Of these compounds, borax, boric acid and borate are preferable, and boric acid is particularly preferable in order to rapidly cause the crosslinking reaction.

As the crosslinking agent for the water-soluble resin, compounds other than the boron compound can also be used.

Examples of such compounds include aldehyde compounds such as formaldehyde, glyoxal, succinaldehyde, glutaraldehyde, dialdehyde starch and plant gum; ketone compounds such as diacetyl, 1,2-cyclopentanedione and 3-hexene-2,5-dione; activated halogenated compounds such as bis(2-chloroethyl)urea, bis(2-chloroethyl)sulfone and 2,4-dichloro-6-hydroxy-s-triazine sodium salt; activated vinyl compounds such as divinylsulfone, 1,3-bis(vinylsulfonyl)-2-propanol, N,N′-ethylenebis(vinylsulfonylacetamide), divinyl ketone, 1,3-bis(acryloyl)urea and 1,3,5-triacryloyl-hexahydro-s-triazine; N-methylol compounds such as dimethylol urea and methylol dimethyl hydantoin; melamine compounds such as trimethylol melamine, alkylated methylol melamine, melamine, benzoguanamine and melamine resin; epoxy compounds such as ethylene glycol diglycidyl ether, propylene glycol diglycidyl ether, polyethylene glycol diglycidyl ether, diglycerin polyglycidyl ether, spiroglycol diglycidyl ether, and phenol resin polyglycidyl ether; isocyanate type compounds such as 1,6-hexamethylene diisocyanate and xylylene diisocyanate; aziridine compounds described in U.S. Pat. No. 3,017,280 and U.S. Pat. No. 2,983,611; carboxyimide compounds described in U.S. Pat. No. 3,100,704; ethyleneimino compounds such as 1,6-hexamethylene-N,N′-bis-ethylene urea; halogenated carboxyaldehyde compounds such as mucochloric acid and mucophenoxychloric acid; dioxane compounds such as 2,3-dihydroxydioxane; metal-containing compounds such as titanium lactate, aluminum sulfate, chrome alum, potassium alum, zirconium acetate and chrome acetate; polyamine compounds such as tetraethylene pentamine; hydrazide compounds such as adipate dihydrazide; a low molecule or a polymer having two or more oxazoline groups; polyvalent acid anhydride, acid chloride and bissulfonate compounds described in U.S. Pat. No. 2,725,294, U.S. Pat. No. 2,725,295, U.S. Pat. No. 2,726,162 and U.S. Pat. No. 3,834,902; and activated ester compounds described in U.S. Pat. No. 3,542,558 and U.S. Pat. No. 3,251,972.

These crosslinking agents can be used alone or as in a combination of two or more thereof.

Mordant

A mordant is used to fix an anionic colorant to the ink-receiving layer.

The mordant is preferably a cationic polymer (cationic mordant) or an inorganic mordant.

As the cationic mordant, a polymer mordant having a primary to tertiary amino group or a quaternary ammonium base as a cationic group is preferably used, but a cationic non-polymer mordant can also be used. From the viewpoint of improving the ink absorbability of the ink-receiving layer, these mordants are preferably compounds having a weight-average molecular weight of 500 to 100,000.

The polymer mordant is preferably a homopolymer of a monomer (mordant monomer) having either a primary to tertiary amino group or a salt thereof or a quaternary ammonium base, or a copolymer of the mordant monomer and another monomer (referred to hereinafter as “non-mordant monomer”) or a polycondensate thereof. These polymer mordants can be used in the form of a water-soluble polymer or water-dispersible latex particles.

The monomer (mordant monomer) includes, for example, trimethyl-p-vinylbenzyl ammonium chloride, trimethyl-m-vinylbenzyl ammonium chloride, triethyl-p-vinylbenzyl ammonium chloride, triethyl-m-vinylbenzyl ammonium chloride, N,N-dimethyl-N-ethyl-N-p-vinylbenzyl ammonium chloride, N,N-diethyl-N-methyl-N-p-vinylbenzyl ammonium chloride, N,N-dimethyl-N-n-propyl-N-p-vinylbenzyl ammonium chloride, N,N-dimethyl-N-n-octyl-N-p-vinylbenzyl ammonium chloride, N,N-dimethyl-N-benzyl-N-p-vinylbenzyl ammonium chloride, N,N-diethyl-N-benzyl-N-p-vinylbenzyl ammonium chloride, N,N-dimethyl-N-(4-methyl)benzyl-N-p-vinylbenzyl ammonium chloride, N,N-dimethyl-N-phenyl-N-p-vinylbenzyl ammonium chloride; trimethyl-p-vinylbenzyl ammonium bromide, trimethyl-m-vinylbenzyl ammonium bromide, trimethyl-p-vinylbenzyl ammonium sulfonate, trimethyl-m-vinylbenzyl ammonium sulfonate, trimethyl-p-vinylbenzyl ammonium acetate, trimethyl-m-vinylbenzyl ammonium acetate, N,N,N-triethyl-N-2-(4-vinylphenyl)ethyl ammonium chloride, N,N,N-triethyl-N-2-(3-vinylphenyl)ethyl ammonium chloride, N,N-diethyl-N-methyl-N-2-(4-vinylphenyl)ethyl ammonium chloride, N,N-diethyl-N-methyl-N-2-(4-vinylphenyl)ethyl ammonium acetate; and quaternary products, with methyl chloride, ethyl chloride, methyl bromide, ethyl bromide, methyl iodide or ethyl iodide, of N,N-dimethylaminoethyl (meth)acrylate, N,N-diethylaminoethyl (meth)acrylate, N,N-dimethylaminopropyl (meth)acrylate, N,N-diethylaminopropyl (meth)acrylate, N,N-dimethylaminoethyl (meth)acrylamide, N,N-diethylamionoethyl (meth)acrylamide, N,N-dimethylaminopropyl (meth)acrylamide or N,N-diethylaminopropyl (meth)acrylamide, as well as their sulfonates, alkyl sulfonates, acetates or alkyl carboxylates whose anions are substituted.

Specific examples of the mordant include monomethyldiallyl ammonium chloride, trimethyl-2-(methacryloyloxy)ethyl ammonium chloride, triethyl-2-(methacryloyloxy)ethyl ammonium chloride, trimethyl-2-(acryloyloxy)ethyl ammonium chloride, triethyl-2-(acryloyloxy)ethyl ammonium chloride, trimethyl-3-(methacryloyloxy)propyl ammonium chloride, triethyl-3-(methacryloyloxy)propyl ammonium chloride, trimethyl-2-(methacryloylamino)ethyl ammonium chloride, triethyl-2-(methacryloylamino)ethyl ammonium chloride, trimethyl-2-(acryloylamino)ethyl ammonium chloride, triethyl-2-(acryloylamino)ethyl ammonium chloride, trimethyl-3-(methacryloylamino)propyl ammonium chloride, triethyl-3-(methacryloylamino)propyl ammonium chloride, trimethyl-3-(acryloylamino)propyl ammonium chloride, triethyl-3-(acryloylamino)propyl ammonium chloride; N,N-dimethyl-N-ethyl-2-(methacryloyloxy)ethyl ammonium chloride, N,N-diethyl-N-methyl-2-(methacryloyloxy)ethyl ammonium chloride, N,N-dimethyl-N-ethyl-3-(acryloyloxylamino)propyl ammonium chloride, trimethyl-2-(methacryloyloxy)ethyl ammonium bromide, trimethyl-3-(acryloyloxylamino)propyl ammonium bromide, trimethyl-2-(methacryloyloxy)ethyl ammonium sulfonate, trimethyl-3-(acryloylamino)propyl ammonium acetate etc.

Other copolymerizable monomers such as N-vinylimidazole, N-vinyl-2-methylimidazole etc. can also be mentioned.

Allyl amine compounds, diallyl amine compounds, and salts thereof can also be used. Examples of such compounds include allyl amine, allylamine hydrochloride, allylamine acetate, allylamine sulfate, diallyl amine, diallylamine hydrochloride, diallylamine acetate, diallylamine sulfate, diallyl methylamine and salts thereof (for example, hydrochloride, acetate, sulfate etc.), diallyl ethylamine and salts thereof (for example, hydrochloride, acetate, sulfate etc.) and diallyldimethyl ammonium salts (whose counter-anions are hydrochloride, acetate, sulfate etc.). These allyl amine compounds and diallyl amine compounds in an amine form are inferior in polymerizability, and are thus polymerized generally in a salt form and then desalted if necessary.

A mordant obtained by polymerizing a unit such as N-vinyl acetamide or N-vinyl formamide and then hydrolyzing the resulting polymer into vinyl amine units, or a salt thereof, can also be used.

The non-mordant monomer refers to a monomer not containing a basic or cationic moiety such as a primary to tertiary amino group or salt thereof or a quaternary ammonium base, and not interacting or insubstantially interacting with a dye in an ink-jet ink.

The non-mordant monomer includes, for example, (meth)acrylates; cycloalkyl (meth)acrylates such as cyclohexyl (meth)acrylate; aryl (meth)acrylates such as phenyl (meth)acrylate; aralkyl esters such as benzyl (meth)acrylate; aromatic vinyls such as styrene, vinyl toluene, and a-methyl styrene; vinyl esters such as vinyl acetate and vinyl propionate; allyl esters such as allyl acetate; halogen-containing monomers such as vinylidene chloride and vinyl chloride; vinyl cyanides such as (meth)acrylonitrile; and olefins such as ethylene and propylene.

The alkyl (meth)acrylates are preferably alkyl (meth)acrylates whose alkyl moiety contains 1 to 18 carbon atoms, such as methyl (meth)acrylate, ethyl (meth)acrylate, propyl (meth)acrylate, isopropyl (meth)acrylate, n-butyl (meth)acrylate, isobutyl (meth)acrylate, t-butyl (meth)acrylate, hexyl (meth)acrylate, octyl (meth)acrylate, 2-ethylhexyl (meth)acrylate, lauryl (meth)acrylate and stearyl (meth)acrylate.

In particular, methyl acrylate, ethyl acrylate, methyl methacrylate, ethyl methacrylate and hydroxyethyl methacrylate are preferable.

The non-mordant monomers can be used alone or as in a combination of two or more thereof.

The polymer mordant includes cyclic amine resin such as polydiallyldimethyl ammonium chloride, a diallyldimethyl ammonium chloride/other monomer (mordant monomer or non-mordant monomer) copolymer, a diallyldimethyl ammonium chloride/SO₂ copolymer, polydiallyl methylamine hydrochloride and polydiallyl hydrochloride, or modified compounds thereof (including copolymers thereof); alkyl (meth)acrylate polymers substituted with secondary amino, tertiary amino or quaternary ammonium salt, such as polydiethylmethacryloyloxy ethylamine, polytrimethylmethacryloyloxyethyl ammonium chloride, polydimethylbenzylmethacryloyloxyethyl ammonium chloride and polydimethylhydroxyethylacryloyloxyethyl ammonium chloride or copolymers thereof with other monomers; polyamine resin such as polyethylene imine compounds, polyallyl amine compounds, and polyvinyl amine compounds; polyamide resin such as polyamide-polyamine resin and polyamide epichlorohydrin resin; polysaccharides such as cationic starch, and chitosan compounds; dicyandiamide compounds such as dicyandiamide/formalin polycondensates and dicyandiamide diethylene triamine polycondensates; polyamidine compounds; dialkylamine epichlorohydrin addition polymers such as dimethylamine epichlorohydrin addition polymers, and modified compounds thereof; and styrene polymers having an alkyl group substituted with a quaternary ammonium salt and copolymers thereof with other monomers.

Specifically, the polymer mordant includes those described in JP-A No. 48-28325, JP-A No. 54-74430, JP-A No. 54-124726, JP-A No. 55-22766, JP-A No. 55-142339, JP-A No. 60-23850, JP-A No. 60-23851, JP-A No. 60-23852, JP-A No. 60-23853, JP-AN No. 60-57836, JP-A No. 60-60643, JP-A No. 60-118834, JP-A No. 60-122940, JP-A No. 60-122941, JP-A No. 60-122942, JP-A No. 60-235134, JP-A No. 1-161236, U.S. Pat. No. 2,484,430, U.S. Pat. No. 2,548,564, U.S. Pat. No. 3,148,061, U.S. Pat. No. 3,309,690, U.S. Pat. No. 4,115,124, U.S. Pat. No. 4,124,386, U.S. Pat. No. 4,193,800, U.S. Pat. No. 4,273,853, U.S. Pat. No. 4,282,305, U.S. Pat. No. 4,450,224, JP-A No. 1-161236, JP-A No. 10-81064, JP-A No. 10-157277, JP-A No. 10-217601, JP-A No. 2001-138621, JP-A No. 2000-211235, JP-A No. 2001-138627, JP-A No. 8-174992, JP-B No. 5-35162, JP-B No. 5-35163, JP-B No. 5-35164, JP-B No. 5-88846, and JP Patent Nos. 2648847 and 2661677.

An inorganic mordant can also be used as the mordant in the invention, and examples thereof includes polyvalent water-soluble metal salts and hydrophobic metal salts.

Examples of the inorganic mordant include salts or complexes of a metal selected from magnesium, aluminum, calcium, scandium, titanium, vanadium, manganese, iron, nickel, copper, zinc, gallium, germanium, strontium, yttrium, zirconium, molybdenum, indium, barium, lanthanum, cerium, praseodymium, neodymium, samarium, europium, gadolinium, dysprosium, erbium, ytterbium, hafnium, tungsten and bismuth.

Specific examples of such compounds include calcium acetate, calcium chloride, calcium formate, calcium sulfate, barium acetate, barium sulfate, barium phosphate, manganese chloride, manganese acetate, manganese formate·2H₂O, ammonium manganese sulfate·6H₂O, cupper(II) chloride, cupper(II) ammonium chloride·2H₂O, copper sulfate, cobalt chloride, cobalt thiocyanate, cobalt sulfate, nickel sulfate·6H₂O, nickel chloride·6H₂O, nickel acetate·4H₂O, ammonium nickel sulfate·6H₂O, nickel amidosulfate·4H₂O, aluminum sulfate, aluminum alum, aluminum sulfite, aluminum thiosulfate, polyaluminum chloride, aluminum nitrate·9H₂O, aluminum chloride·6H₂O, basic aluminum sulfate, basic aluminum nitrate, basic aluminum formate, basic aluminum acetate, basic aluminum glycinate, ferrous bromide, ferrous chloride, ferric chloride, ferrous sulfate, ferric sulfate, zinc phenolsulfonate, zinc bromide, zinc chloride, zinc nitrate·6H₂O, zinc sulfate, titanium tetrachloride, tetraisopropyl titanate, titanium acetylacetonate, titanium lactate, zirconium acetylacetonate, zirconyl acetate, zirconyl sulfate, ammonium zirconium carbonate, zirconyl stearate, zirconyl octylate, zirconyl nitrate, zirconium oxychloride, zirconium hydroxychloride, zirconyl lactate, zirconyl succinate, zirconyl oxalate, ammonium zirconium acetate, potassium zirconium carbonate, basic zirconium glycinate, chrome acetate, chrome sulfate, magnesium sulfate, magnesium chloride·6H₂O, magnesium citrate·9H₂O, sodium phosphotungstate, tungsten sodium citrate, 12-tungustophosphoric acid·nH₂O, 12-tungstosilicic acid-26H₂O, molybdenum chloride, 12-molybdophoshoric acid·nH₂O, gallium nitrate, germanium nitrate, strontium nitrate, yttrium acetate, yttrium chloride, yttrium nitrate, indium nitrate, lanthanum nitrate, lanthanum chloride, lanthanum acetate, lanthanum benzoate, cerium chloride, cerium sulfate, cerium octylate, praseodymium nitrate, neodymium nitrate, samarium nitrate, europium nitrate, gadolinium nitrate, dysprosium nitrate, erbium nitrate, ytterbium nitrate, hafnium chloride and bismuth nitrate.

The inorganic mordant is preferably an aluminum-containing compound, a titanium-containing compound, a zirconium-containing compound, or a compound (salt or complex) of the group IIIB metals in the periodic table.

When the mordant is used as an agent for fixing an anionic colorant, a solution containing the mordant can be separately applied by dipping, curtain coating, extrusion, or the like onto the coating solution, that forms an ink-receiving layer, that has dried after coating or is drying (in a half-dry state).

Other Components

If necessary, the image-receiving material of the invention can further contain a wide variety of known additives such as an acid, a UV absorber, an antioxidant, a fluorescent brightener, a monomer, a polymerization initiator, a polymerization inhibitor, a bleeding inhibitor, a preservative, a viscosity stabilizer, a defoaming agent, a surfactant, an antistatic agent, a matting agent, a curling inhibitor, and a water resistance-conferring agent.

Acid

Examples of the acid include formic acid, acetic acid, glycolic acid, oxalic acid, propionic acid, malonic acid, succinic acid, adipic acid, maleic acid, malic acid, tartaric acid, citric acid, benzoic acid, phthalic acid, isophthalic acid, glutaric acid, gluconic acid, lactic acid, aspartic acid, glutamic acid, salicylic acid, metal salicylate (salicylate salts such as those of Zn, Al, Ca or Mg), methanesulfonic acid, itaconic acid, benzenesulfonic acid, toluenesulfonic acid, trifluoromethanesulfonic acid, styrenesulfonic acid, trifluoroacetic acid, barbituric acid, acrylic acid, methacrylic acid, cinnamic acid, 4-hydroxybenzoic acid, aminobenzoic acid, naphthalenedisulfonic acid, hydroxybenzenesulfonic acid, toluenesulfinic acid, benzenesulfinic acid, sulfanilic acid, sulfamic acid, α-resorcylic acid, β-resorcylic acid, γ-resorcylic acid, gallic acid, fluoroglycine, sulfosalicylic acid, ascorbic acid, erysorbic acid, bisphenolic acid, hydrochloric acid, nitric acid, sulfuric acid, phosphoric acid, polyphosphoric acid, boric acid and boronic acid. The amount of these acids to be added may be determined such that the pH of the surface of the ink-receiving layer is adjusted to be within a range of from 3 to 8.

The acid may be used in the form of a metal salt (for example, a salt of sodium, potassium, calcium, cesium, zinc, copper, iron, aluminum, zirconium, lanthanum, yttrium, magnesium, strontium or cerium) or an amine salt (for example, ammonia, triethylamine, tributylamine, piperazine, 2-methylpiperazine, or polyallylamine). Examples of the metal salt include polyaluminum chloride, zirconium oxychloride, zirconium acetate, etc.

UV Absorber, Antioxidant and Blurring Inhibitor

Examples of the UV absorber, antioxidant and blurring inhibitor include alkylated phenol compounds (including hindered phenol compounds), alkylthiomethyl phenol compounds, hydroquinone compounds, alkylated hydroquinone compounds, tocopherol compounds, aliphatic, aromatic and/or heterocyclic compounds having thioether bonds, bisphenol compounds, O-, N- and S-benzyl compounds, hydroxybenzyl compounds, triazine compounds, phosphonate compounds, acylaminophenol compounds, ester compounds, amide compounds, ascorbic acid, amine compound antioxidants, 2-(2-hydroxyphenyl)benzotriazole compounds, 2-hydroxybenzophenone compounds, acrylate, water-soluble or hydrophobic metal salts, organic metal compounds, metal complexes, hindered amine compounds (including TEMPO compound), 2-(2-hydroxyphenyl)-1,3,5-triazine compound, metal inactivating agents, phosphite compounds, phosphonite compounds, hydroxyamine compounds, nitron compounds, peroxide scavengers, polyamide stabilizers, polyether compounds, basic assistant stabilizers, nucleating agents, benzofuranone compounds, indolinone compounds, phosphine compounds, polyamine compounds, thiourea compounds, urea compounds, hydrazide compounds, amidine compounds, sugar compounds, hydroxybenzoic acid compounds, dihydroxybenzoic acid compounds and trihydroxybenzoic acid compounds.

Among these compounds, preferable examples are alkylated phenol compounds, aliphatic, aromatic and/or heterocyclic compounds having thioether bonds, bisphenol compounds, ascorbic acid, amine compound antioxidants, water-soluble or hydrophobic metal salts, organometallic compounds, metal complexes, hindered amine compounds, hydroxyamine compounds, polyamine compounds, thiourea compounds, hydrazide compounds, hydroxybenzoic acid compounds, dihydroxybenzoic acid compounds and trihydroxybenzoic acid compounds.

Examples of such compounds include those described in JP-A No. 2002-13005, JP-A No. 10-182621, JP-A No. 2001-260519, JP-B No. 4-34953, JP-B No. 4-34513, JP-A No. 11-170686, JP-B No. 4-34512, EP1138509, JP-A No. 60-67190, JP-A No. 7-276808, JP-A No. 2001-94829, JP-A No. 47-10537, JP-A No. 58-111942, JP-A No. 58-212844, JP-A No. 59-19945, JP-A No. 59-46646, JP-A No. 59-109055, JP-A No. 63-53544, JP-B No. 36-10466, JP-B No. 42-26187, JP-B No. 48-30492, JP-B No. 48-31255, JP-B No. 48-41572, JP-B No. 48-54965, JP-B No. 50-10726, U.S. Pat. No. 2,719,086, U.S. Pat. No. 3,707,375, U.S. Pat. No. 3,754,919, U.S. Pat. No. 4,220,711, JP-B No. 45-4699, JP-B No. 54-5324, European Patent Laid-Open Nos. 223739, 309401, 309402, 310551, 310552 and 459416, German Patent Laid-Open No. 3435443, JP-A No. 54-48535, JP-A No. 60-107384, JP-A No. 60-107383, JP-A No. 60-125470, JP-A No. 60-125471, JP-A No. 60-125472, JP-A No. 60-287485, JP-A No. 60-287486, JP-A No. 60-287487, JP-A No. 60-287488, JP-A No. 61-160287, JP-A No. 61-185483, JP-A No. 61-211079, JP-A No. 62-146678, JP-A No. 62-146680, JP-A No. 62-146679, JP-A No. 62-282885, JP-A No. 62-262047, JP-A No. 63-051174, JP-A No. 63-89877, JP-A No. 63-88380, JP-A No. 66-88381, JP-A No. 63-113536, JP-A No. 63-163351, JP-A No. 63-203372, JP-A No. 63-224989, JP-A No. 63-251282, JP-A No. 63-267594, JP-A No. 63-182484, JP-A No. 1-239282, JP-A No. 2-262654, JP-A No. 2-71262, JP-A No. 3-121449, JP-A No. 4-291685, JP-A No. 4-291684, JP-A No. 5-61166, JP-A No. 5-119449, JP-A No. 5-188687, JP-A No. 5-188686, JP-A No. 5-110490, JP-A No. 5-170361, JP-B No. 48-43295, JP-B No. 48-33212, U.S. Pat. No. 4,814,262 and U.S. Pat. No. 4,980,275.

The other components described above may be used alone or as in a combination of two or more thereof. The other components may be added after being rendered water-soluble or dispersible, or may be formed into a polymer dispersion, an emulsion or oil droplets, or encapsulated in microcapsules. The amount of the other components added to the image-receiving material of the invention is preferably 0.01 to 10 g/m².

In the invention, the ink-receiving layer coating solution preferably contains a surfactant. The surfactant used may be a cationic, anionic, nonionic, amphoteric, fluorine or silicon surfactant.

The nonionic surfactant includes polyoxyalkylene alkyl ethers and polyoxyalkylene alkyl phenyl ethers (for example, diethylene glycol monoethyl ether, diethylene glycol diethyl ether, polyoxyethylene lauryl ether, polyoxyethylene stearyl ether, polyoxyethylene nonyl phenyl ether etc.), oxyethylene-oxypropylene block copolymers, sorbitan fatty esters (for example, sorbitan monolaurate, sorbitan monooleate, sorbitan trioleate etc.), polyoxyethylene sorbitan fatty esters (for example, polyoxyethylene sorbitan monolaurate, polyoxyethylene sorbitan monooleate, polyoxyethylene sorbitan trioleate etc.), polyoxyethylene sorbitol fatty esters (for example, polyoxyethylene sorbitol tetraoleate etc.), glycerin fatty esters (for example, glycerol monooleate etc.), polyoxyethylene glycerin fatty esters (polyoxyethylene glycerin monostearate, polyoxyethylene glycerin monooleate etc.), polyoxyethylene fatty esters (polyethylene glycol monolaurate, polyethylene glycol monooleate etc.) and polyoxyethylene alkyl amines, acetylene glycols (for example, 2,4,7,9-tetramethyl-5-decyn-4,7-diol, and other diol ethylene oxide addition products, propylene oxide addition products) etc., among which polyoxyalkylene alkyl ethers are preferable. The nonionic surfactant can be used in both the first and second coating solutions. The nonionic surfactants may be used singly or in combination thereof.

The amphoteric surfactant includes those of amino acid type, carboxy ammonium betaine type, sulfone ammonium betaine type, ammonium sulfate betaine type and imidazolium betaine type, and for example, those surfactants described in U.S. Pat. No. 3,843,368, JP-A No. 59-49535, JP-A No. 63-236546, JP-A No. 5-303205, JP-A No. 8-262742, JP-A No. 10-282619, JP Patent No. 2514194, JP Patent No. 2759795 and JP-A No. 2000-351269 can be preferably used. The amphoteric surfactants are preferably those of amino acid type, carboxy ammonium betaine type and sulfone ammonium betaine type. The amphoteric surfactants may be used singly or in combination thereof.

The anionic surfactant includes aliphatic acid salts (for example, sodium stearate and potassium oleate), alkyl sulfates (for example, sodium laurylsulfate and lauryl sulfate triethanolamine), sulfonates (for example, sodium dodecylbenzenesulfonate), alkylsulfosuccinates (for example, sodium dioctylsulfosuccinate), alkyl diphenyl ether disulfonates, alkyl phosphates etc.

The cationic surfactant includes alkylamine salts, quaternary ammonium salts, pyridinium salts, imidazolium salts etc.

The fluorine surfactant includes compounds derived from intermediates having a perfluoroalkyl group by a method such as electrolytic fluorination, telomerization or oligomerization.

For example, mention is made of perfluoroalkyl sulfonates, perfluoroalkyl carboxylates, perfluoroalkyl ethylene oxide addition products, perfluoroalkyl trialkyl ammonium salts, perfluoroalkyl group-containing oligomers, perfluoroalkyl phosphates etc.

The silicon surfactant is preferably an organic group-modified silicon oil which can have a siloxane structure modified at side chains, both ends or one end with organic groups. The organic group-modified group includes an amino-, polyether-, epoxy-, carboxyl-, carbinol-, alkyl-, aralkyl-, phenol- or fluorine-modified groups.

In the invention, the content of the surfactant is preferably 0.001 to 2.0%, more preferably 0.01 to 1.0%, based on the ink-receiving layer coating solution. When two or more solutions are used as the ink-receiving layer coating solution, the surfactant is added preferably to both the coating solutions.

In the invention, the ink-receiving layer contains a high-boiling organic solvent for prevention of curling and/or regulation of glass transition temperature. The high-boiling organic solvent is a water-soluble or hydrophobic organic compound having a boiling point of 150° C. or more at normal pressures. The high-boiling organic compound may be a low molecule or a polymer in the form of liquid or solid at room temperature.

Specifically, mention is made of aromatic carboxylates (for example, dibutyl phthalate, diphenyl phthalate, phenyl benzoate etc.), aliphatic carboxylates (for example, dioctyl adipate, dibutyl sebacate, methyl stearate, dibutyl maleate, dibutyl fumarate, triethyl acetylcitrate etc.), phosphates (for example, trioctyl phosphate, tricresyl phosphate etc.), epoxy compounds (for example, epoxylated soybean oil, epoxylated methyl fatty ester etc.), alcohols (for example, stearyl alcohol, ethylene glycol, propylene glycol, diethylene glycol, triethylene glycol, glycerin, diethylene glycol monobutyl ether (DEGMBE), triethylene glycol monobutyl ether, glycerin monomethyl ether, 1,2,3-butane triol, 1,2,4-butane triol, 1,2,4-pentane triol, 1,2,6-hexane triol, thiodiglycol, triethanol amine, polyethylene glycol etc.), vegetable oils (for example, soybean oil, sunflower oil etc.) and higher aliphatic carboxylic acids (for example, linolic acid, oleic acid etc.).

Support

Either a transparent support made of a transparent material such as plastic or an opaque support made of an opaque material such as paper may be used as the support for the recording medium according to the invention. Use of a paper support is preferable for rasing an ink absorbing speed of ink-receiving layer. It is also possible to form an ink-receiving layer on the label surface of an optical disk, for example, by using a read-only optical disk such as CD-ROM or DVD-ROM, a recordable optical disk such as CD-R or DVD-R, or a rewritable optical disk as the support.

A transparent material resistant to radiant heat, which is applied when the medium is used on an OHP or back light display, is preferable as the material for the transparent support. Examples of the materials include polyesters such as polyethylene terephthalate (PET), polysulfone, polyphenylene oxide, polyimide, polycarbonate, polyamide, and the like. Among them, polyesters are preferable, and polyethylene terephthalate is particularly preferable. The thickness of the transparent support is not particularly limited, but is preferably 50 to 200 μm from the viewpoint of ease of handling.

The high-gloss opaque support preferably has a glossiness of 40% or more on the surface where the ink-receiving layer is formed. The glossiness is a value determined by a known method, i.e., 75-degree mirror surface glossiness test procedure for paper and cardboard. Specific examples of the supports include the following:

High-gloss paper supports such as art paper, coated paper, cast-coated paper, baryta paper commonly used as a silver salt photographic support and the like; high-gloss films opacified by adding a white pigment or the like to any one of plastic films including polyesters such as polyethylene terephthalate (PET), nitrocellulose, cellulose acetate, cellulose esters such as cellulose acetate butylate, polysulfone, polyphenylene oxide, polyimide, polycarbonate, polyamide and the like (which may be additionally surface calendered); supports having a polyolefin coated layer containing or not containing a white pigment formed on the surface of these various paper and transparent supports or the high-gloss films containing a white pigment or the like; as examples. Expanded polyester films containing a white pigment (e.g., expanded PET prepared by stretching a polyolefin microparticle-containing PET film and thus forming voids therein) are favorable and also included as examples. In addition, resin coated papers commonly used as photographic papers for silver photographs are also favorable.

The thickness of the opaque support is also not particularly limited, but preferably 50 to 300 μm from the viewpoint of ease of handling.

The surface of support may be subjected to corona discharge treatment, glow discharge treatment, flame treatment, ultraviolet ray irradiation treatment, or the like for improvement in ink compatibility and adhesiveness.

Hereinafter, base paper for the resin-coated paper will be described in detail.

The base papers are prepared by sheeting a primary raw material of wood pulp and additionally a synthetic pulp such as polypropylene, or a synthetic fiber such as nylon or polyester as needed. The wood pulp may be any one of LBKP, LBSP, NBKP, NBSP, LDP, NDP, LUKP, and NUKP; but LBKP, NBSP, LBSP, NDP, and LDP, which contain a greater amount of short fibers, are preferable. However, the ratio of LBSP and/or LDP is 10% or more and 70% or less by mass.

Chemical pulps (sulfate salt pulp and sulfite pulp) containing a smaller amount of impurities are favorably used, and bleached pulps higher in whiteness are also useful.

Various additives including higher fatty acid, sizing agent such as alkylketene dimer, white pigment such as calcium carbonate, talc and titanium oxide, paper-strength additive such as starch, polyacrylamide, and polyvinyl alcohol, fluorescent whitening agent, moisturizing agent such as polyethylene glycols, dispersant, softener such as quaternary ammonium, and the like may be added to the base paper as needed.

The freeness of the pulp for use in sheeting is preferably 200 to 500 ml as per CSF (Canadian Standard Freeness) regulations In regard to the fiber length after beating, the pulps remaining on 24- and 42-mesh screens is preferably 30 to 70% by mass, as determined by the known method of a screening test for paper pulp. Further, the pulp remaining on 4-mesh screen is preferably 20% by mass or less.

The basis weight of the base paper is preferably 30 to 250 g and more preferably 50 to 200 g. The thickness of the base paper is preferably 40 to 250 μm. The base paper may be calendered to improve surface smoothness during or after the sheeting step. The density of the base paper is generally 0.7 to 1.2 g/m² as determined by the known test procedure for determination the thickness and density of paper.

In addition, the stiffness of the base paper is preferably 20 to 200 g as determined by the known test procedure for determining the stiffness of paper by using a Clark stiffness tester.

A surface-sizing agent may be applied to the surface of the base paper, and sizing agents similar to those that may be added to the base paper can be used as the surface sizing agent. The pH of the base paper is preferably 5 to 9, as determined by the known hot-water extraction method specified in the test for determining the tensile properties of paper.

The polyethylene covering the front and rear surfaces of the base paper is mainly a low-density polyethylene (LDPE) and/or a high-density polyethylene (HDPE), but other LLDPE, polypropylene, or the like may also be used partially.

In particular, the polyethylene layer on the ink-receiving layer side is preferably one of the polyethylenes containing rutile or anatase titanium oxide, a fluorescent whitening agent, or ultramarine that are improved in opacity, whiteness and hue, which are commonly used in photographic papers. The content of the titanium oxide is preferably about 3 to 20% and more preferably 4 to 13% by mass with respect to the polyethylene. The thickness of the polyethylene layer, either front or rear, is not particularly limited, but is favorably 10 to 50 μm. In addition, an undercoat layer may be formed on the polyethylene layer for increasing the adhesiveness thereof to an ink-receiving layer. Hydrophilic polyester, gelatin, and PVA are preferable for the undercoat layer. The thickness of the undercoat layer is preferably 0.01 to 5 μm.

The polyethylene-coated paper may be used as a glossy paper, and the polyethylene layer coated on the surface of the base paper by melt-extrusion may be further subjected to a surface modification treatment such as embossing so that it has a mat or silky surface similar to that of common photographic printing papers.

Additionally, a backcoat layer may also be formed on the support, and components such as white pigment, aqueous binder, and other components may be added to the backcoat layer.

Examples of the white pigments contained in the backcoat layer include white inorganic pigments such as light calcium carbonate, heavy calcium carbonate, kaolin, talc, calcium sulfate, barium sulfate, titanium dioxide, zinc oxide, zinc sulfide, zinc carbonate, satin white, aluminum silicate, diatomaceous soil, calcium silicate, magnesium silicate, synthetic amorphous silica, colloidal silica, colloidal alumina, pseudoboehmite, aluminum hydroxide, alumina, lithopone, zeolite, hydrated hallosite, magnesium carbonate, and magnesium hydroxide; organic pigments such as styrene-based plastic pigment, acrylic plastic pigment, polyethylene, microcapsule, urea resin, and melamine resin; and the like.

Examples of the aqueous binders for use in the backcoat layer include water-soluble polymers such as styrene/maleic acid salt copolymers, styrene/acrylate salt copolymers, polyvinyl alcohol, silanol-modified polyvinyl alcohols, starch, cationic starch, casein, gelatin, carboxymethylcellulose, hydroxyethylcellulose, and polyvinylpyrrolidone; water-dispersible polymers such as styrene butadiene latexes and acryl emulsions; and the like. The other components contained in the backcoat layer include defoaming agent, antifoaming agent, dye, fluorescent whitening agent, antiseptic, water-resistance imparting agent, and the like.

Preparation of the Image-Receiving Material

The image-receiving material is prepared by applying the ink-receiving layer coating solution on the support. The ink-receiving layer coating solution is prepared by dispersing or dissolving the respective components for forming the ink-receiving layer in a solvent, preferably an aqueous solvent.

Water, an organic solvent or a mixed solvent thereof can be used as the solvent. The organic solvent includes alcohols such as methanol, ethanol, n-propanol, i-propanol and methoxy propanol, ketones such as acetone and methyl ethyl ketone, tetrahydrofuran, acetonitrile, ethyl acetate, toluene etc.

Application of the ink-receiving layer coating solution can be carried out by a known coating method using, for example, an extrusion die coater, an air doctor coater, a bread coater, a rod coater, a knife coater, a squeeze coater, a reverse roll coater or a bar coater.

The image-receiving material of the invention can be applied, for example, to ink jet recording and a recording system using an ink pen.

Ink Jet Recording Method

The ink jet recording method of the invention comprises recording on the above-described image-receiving material with at least one of dispersed ink, pigment ink, water-soluble dye ink, photo-curable ink and solvent ink, and subjecting the resulting image-receiving material to smoothing treatment. By this smoothing treatment, an image excellent in glossiness is formed.

For smoothing, a method of pressing a printed face (pressing smoothing), a heating method (heating smoothing), a heating/pressing method (heating/press smoothing) etc. can be mentioned. In the case of heating smoothing, the image-receiving material is cooled after heating if necessary.

The pressing means used in pressing smoothing includes a method of allowing the image-receiving material after printing to pass through a pressing region (nip) between a pair of press rolls. As the press rolls, metal rolls made of stainless steel or the like whose surfaces have been smoothed by plating with hard chrome etc. are used. The pressing condition is about 16 to 30 kg/cm.

The heating means used in heating smoothing includes a method of heating by radiant heat from an infrared light lamp, a flat heater etc. The heating temperature on the surface of the image-receiving material is selected suitably depending on the Tg of the porous layer, but is usually about 80 to 160° C.

The heating and pressing means used in heating/press smoothing includes a method of allowing the image-receiving material after printing to pass through a nip between a pair of heating rolls having at least one heating means provided in the rolls, a method of allowing the image-receiving material after printing to pass through a nip between a press roll and a heating belt, etc.

For a pair of the heating rolls, metal rolls made of aluminum, stainless steel or the like having a releasing layer made of silicone resin (silicone rubber), fluorine resin (fluorine rubber) or the like formed thereon are used. An elastic layer may be formed under the releasing layer. As the heating means provided in the rolls, a known heating means such as a halogen lamp, an electric heating system or a dielectric heating system can be used.

The heating temperature on the surface of the image-receiving material in heating/press smoothing with a pair of heating rolls can be selected suitably depending on the Tg of the porous layer, but is generally about 80 to 160° C. The pressing condition is generally about 1 to 30 kg/cm.

The heating belt used in heating/press smoothing has a plurality of rolls and a belt stretched between the rolls, and one of the rolls has a heating means provided inside. A press roll forming a nip is provided against the roll provided with a heating means. In the press roll, a heating means may also be provided. As the heating means provided in the roll, a known heating means such as a halogen lamp, an electric heating system or a dielectric heating system can be used.

As a pair of rolls opposite to each other, metal rolls made of aluminum, stainless steel or the like having a releasing layer made of silicone resin (silicone rubber), fluorine resin (fluorine rubber) or the like formed thereon are used. As the belt, a belt can be used that has a releasing layer containing rubber excellent in heat resistance and releasability such as silicon compound rubber, fluorine compound rubber or silicone/fluorine compound rubber, which in consideration of heat resistance and mechanical strength, is formed on a metal sheet made of nickel, aluminum or stainless steel or on a resin film such as PET, PBT, polyester, polyimide or polyimide amide.

In press smoothing using a heating belt and press rolls, the heating temperature on the surface of the image-receiving material is selected suitably depending on the Tg of the porous layer, but is usually about 80 to 160° C. The press condition is about 1 to 30 kg/cm.

When the heating belt is released from the surface of the image-receiving material after heating, the heating belt is preferably cooled before release in order to allow a smoother release surface.

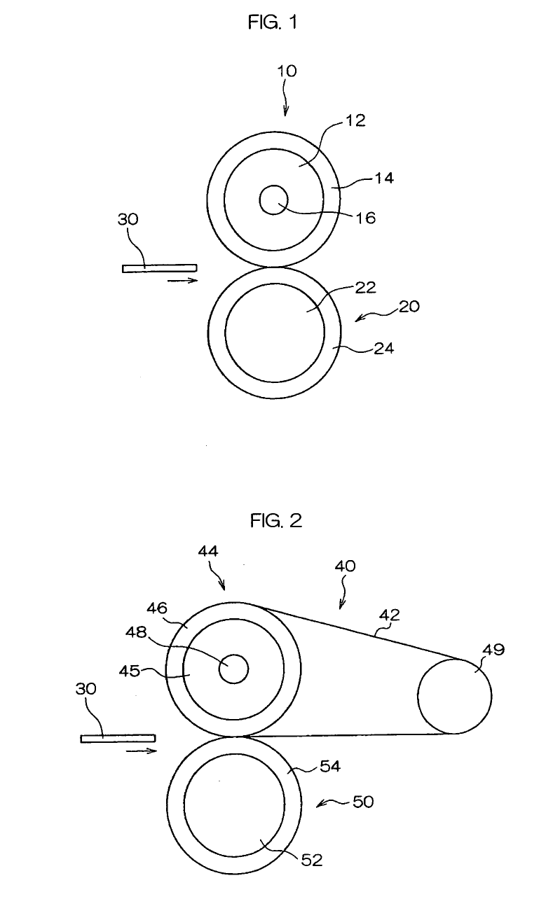

FIG. 1 shows one example of the heating rolls used in heating/press smoothing. In FIG. 1, 10 and 20 are rolls, 12 and 22 are metal rolls, and 14 and 24 are releasing layers. In roll 10, for example, a halogen lamp is provided as a heating means 16. 30 is a printed image-receiving material, and made to pass through a nip between the pair of rolls to smooth the printed image.

FIG. 2 shows another means used in heating and press smoothing, wherein 40 is a heating belt, 42 is a belt, 44 is a heating roll, 45 is a metal roll, 46 is a releasing layer, 48 is a heating means such as a halogen lamp, and 49 is a support roll. 50 is a press roll forming a nip with the heating roll 44, 52 is a metal roll, and 54 is a releasing layer.

The ink jet recording ink used in the ink jet recording method of the invention makes use of one ink selected from dispersed ink, pigment ink, water-soluble dye ink, photo-curable ink and solvent ink.

Dispersed Ink

The dispersed ink is an ink having a dispersion of colored fine particles comprising an oil-soluble dye encapsulated in an oil-soluble polymer, which is obtained by mixing at least one kind of oil-soluble dye, at least one kind of oil-soluble polymer and at least one kind of a low-boiling organic solvent (with a water solubility of 25 g or less) to prepare an oil phase (organic phase), adding the resulting oil phase to water (aqueous phase), and emulsifying and dispersing the mixture with an emulsifier such as a homogenizer.

By adding a water-soluble compound (including a polymer) having a hydrophobic group at the terminus thereof to a dispersion of the colored fine particles, the colored fine particles (dispersed droplets) can be effectively prevented from being aggregated, and thus maintained stably in a uniformly dispersed state.

The dispersed ink is described in detail in Japanese Patent Application No. 2003-24530, and the dispersed ink described therein can be used in the recording method of the invention.

The oil-soluble dye refers to a colorant substantially insoluble in water, and specifically to a colorant whose solubility in water at 25° C. (that is, the mass of the colorant which can be dissolved in 100 g water) is 1 g or less. The solubility is preferably in the range of 0.5 g or less, more preferably 0.1 g or less. The oil-soluble dye is preferably one having a melting point of 200° C. or less, more preferably 150° C. or less, still more preferably 100° C. or less. When the melting point of the oil-soluble dye is low, the dye can be prevented from precipitating as crystals, thus improving the dispersion stability of ink jet recording ink and storage stability during storage over time.

Examples of the oil-soluble dye include dyes such as anthraquinone compounds, naphthoquinone compounds, styryl compounds, indoaniline compounds, azo compounds, nitro compounds, coumarin compounds, methine compounds, porphyrin compounds, azaporphyrin compounds and phthalocyanine compounds. For full-color printing, at least 4 colors, that is, 3 primary colors (yellow (Y), magenta (M) and cyan (C)) plus black (K), are necessary. As specific examples of these 4-color colorants and the content thereof in ink, those described in paragraphs 0030 to 0213 in the specification supra can apply.

The oil-soluble polymer is polyester, an addition polymer, or the like, and as examples of the polymer and the amount of the polymer added to the oil-soluble dye, those described in paragraphs 0217 to 0239 in the specification supra can apply.

The low-boiling organic solvent is added as a solvent for the oil-soluble polymer and oil-soluble dye, to reduce the diameters of dispersed particles in the emulsified dispersion. After dispersion and emulsification, the low-boiling organic solvent is removed preferably by heating under reduced pressure, by ultrafiltration, etc. The boiling point is 100° C. or less, preferably 80° C. or less, particularly preferably 70° C. or less. Specific examples are described in paragraphs 0295 to 0296 in the specification supra.

A high-boiling organic solvent can also be added to regulate the glass transition temperature, etc. of the oil-soluble polymer and improve the stability of the dispersion, etc.

The high-boiling organic solvent is an organic solvent having a boiling point of 200° C. or more and a melting point of 80° C. or less, preferably having a water solubility of 4 g or less in water at 25° C. When the water solubility (25° C.) is higher than 4 g, the colored fine particles in the ink composition tend to have a larger diameter and aggregate, which may have a serious adverse effect on ink discharge. The water solubility is preferably 4 g or less, more preferably 3 g or less, still more preferably 2 g or less, and even more preferably 1 g or less. As specific examples of the high-boiling solvent and the amount of the solvent added, those described in paragraphs 0260 to 0293 in the specification supra can apply.

The water-soluble polymer having a hydrophobic group at the terminus thereof refers to a polymer having a hydrophobic group or a hydrophobic polymer bound to a water-soluble polymer via a divalent linking group having a hetero linkage.

The hydrophobic group is an aliphatic group, aromatic group, heterocyclic group or the like (specifically those described in paragraphs 0306 to 0314 in the specification supra), and the hydrophobic polymer is a polystyrene compound, a polymethacrylate compound, a polyacrylate compound, or polyvinyl chloride or the like. The divalent linking group having a hetero linkage refers to an ether linkage, ester bond, thioether linkage, thioester bond etc. The water-soluble polymer includes, for example, polymers obtained by polymerizing at least one member of a vinyl alcohol compound monomer, an unsaturated carboxylic acid monomer, an unsaturated sulfonic acid monomer and an unsaturated phosphonic acid monomer, or by polymerizing monomers including vinyl ester compound monomers (vinyl acetate, vinyl formate, vinyl propionate etc.) in addition to the above monomers, as well as polymers containing —CH₂—C(R)(OH)—CH₂—O— (R is a hydrogen atom or an alkyl group having 1 to 10 carbon atoms) as a repeating unit.

As examples of the water-soluble polymer having a hydrophobic group at the terminus thereof and the content of the polymer in ink, those described in paragraphs 0329 to 0332 in the specification supra can apply.

In addition to the components described above, other water-soluble polymers (described in paragraph 0336 in the specification supra) and surfactants (described in paragraph 0337 in the specification supra) can be used as necessary.

The average particle diameter of the dispersed ink is preferably 0.1 μm or less, particularly 0.01 to 0.1 μm.

Pigment Ink

The pigment ink is prepared by adding a water-insoluble organic pigment to an aqueous medium containing a surfactant and a dispersed polymer and pulverizing the mixture with hard beads in a disperser such as a sand mill or a ball mill. In this pigment ink, the water-soluble polymer having a hydrophobic group at the terminus thereof, described above in the description of the dispersed ink, is allowed to coexist with a pigment, whereby the pigment can be dispersed uniformly and stably without aggregation in an aqueous medium. Such pigment ink is disclosed in detail in Japanese Patent Application No. 2003-24004, and used in the recording method of the invention. As the water-soluble polymer having a hydrophobic group at the terminus thereof and as the content of the polymer in ink, those described in paragraphs 0023 to 0056 in the specification supra can apply, and as the content of the usable pigment and the content of the pigment in ink, those described in paragraphs 0057 to 0058 in the specification supra can apply.

Water-Soluble Dye Ink

The water-soluble dye ink is an ink having a water-soluble dye dissolved in an aqueous medium. The water-soluble dye ink is characterized by high transparency and color density. The water-soluble dye is excellent in stability in water, but does precipitate in a rare case during storage, and such precipitation occurring in a nozzle causes liquid clogging. Accordingly, when a water-soluble polymer having a hydrophobic group or a hydrophobic polymer bound via a divalent linking group having a hetero linkage to a water-soluble polymer containing —CH₂—C(R)(OH)—CH₂—O— (R is a hydrogen atom or an alkyl group having 1 to 10 carbon atoms) as a repeating unit, similar to the polymer described above, is added to the water-soluble dye ink, the dye can be prevented from aggregating during storage. Therefore, the water-soluble dye ink can be prevented from causing liquid clogging in a nozzle and is excellent in cleaning even if liquid clogging occurs. Such water-soluble dye ink is described in detail in Japanese Patent Application No. 2003-100492, and as the usable water-soluble dye and the content of the water-soluble dye in ink, those described in columns 0045 to 0056 in the specification supra can apply, and as the hydrophobic group-containing water-soluble polymer and the content of the polymer in ink, those described in columns 0019 to 0043 in the specification supra can apply.

Photo-Curable Ink

The photo-curable ink is an ink polymerized and cured by irradiation with light (UV rays etc.) after printing, and contains at least a coloring agent, a photo-curable oligomer and/or a monomer and a photopolymerization initiator, and such photo-curable ink include aqueous and non-aqueous inks, both of which can be used. As the aqueous photo-curable ink, it is possible to employ, for example, those described in paragraphs 0035 to 0053 and 0056 to 0065 in JP-A No. 2001-323194 [photo-curable monomer/oligomer (colunms 0035 to 0037), photopolymerization initiator (0038 to 0040), coloring agent (0041 to 0048), aqueous medium (0051 to 0052)] and those described in paragraphs 0015 to 0078 and 0089 to 0093 in JP-A No. 2000-336295 [photopolymerizable urethane oligomer/monomer (0016 to 0028), photopolymerizable initiator (0030 to 0032), coloring agent (0030 to 0038), aqueous medium (0043 to 0044)]. As the non-aqueous photo-curable ink, it is possible to employ, for example, those described in paragraphs 0005 to 0048 in JP-A No. 2003-147233 [pigment (0013), UV-curable compound (0014 to 0019), photopolymerization initiator and sensitizer (0020 to 0023)].

As another photo-curable ink, mention is made of an ink which is the same as the above-mentioned dispersed ink except that along with a photopolymerization initiator, a photopolymerizable monomer is used in place of the oil-soluble polymer. As examples of the photopolymerizable monomer and the amount of the added monomer relative to the oil-soluble dye, those described in paragraphs 0242 to 0248 in Japanese Patent Application No. 2003-24530 supra can apply. As the photopolymerization initiator and the amount of the initiator added, those described in paragraphs 0249 to 0255 in Japanese Patent Application No. 2003-24530 can apply.

By polymerizing and curing the photopolymerizable monomer by light such as UV rays after printing, a printed image can be fixed onto an arbitrarily selected recording material to improve the stability of the image, that is, water resistance, light resistance (particularly ozone resistance), and rubbing resistance.

Solvent Ink

The solvent ink is an ink having an oil-soluble dye dissolved in an organic solvent. As the oil-soluble dye, the oil-soluble dye described in the above-mentioned dispersed ink can be similarly used. As the organic solvent, use can be made of organic solvents described on page 4, lower right column, line 5 from the bottom, to page 5, lower right column, line 5, and page 5, upper left column, line 2 to lower left column, line 7 in JP-A No. 63-60784 where the solvent ink is described.

### EXAMPLES

Hereinafter, the present invention is described in more detail by reference to the Examples, but the invention is not limited to the Examples. In the Examples, the terms “parts” and “%” refer to “parts by mass” and “% by mass” respectively unless otherwise specified.

Preparation of Support A

Wood pulp composed of 100 parts of LBKP was beaten with a double disk refiner to a Canadian freeness of 300 ml, and 0.5 parts of epoxylated behenic amide, 1.0 part of anion polyacrylamide, 0.1 parts of polyamide polyamine epichlorohydrin and 0.5 parts of cation polyacrylamide, all of which are expressed in terms of the ratio thereof on an oven-dry mass basis relative to the pulp, were added and weighed with a wire paper machine to prepare a base paper of 170 g/m².

For regulation of the surface size of the base paper, the base paper was impregnated, in an amount of 0.5 g/m² on an oven-dry mass basis, with 4% aqueous polyvinyl alcohol containing 0.04% luminescent brightener (trade name: WHITEX BB, manufactured by Sumitomo Chemical Co., Ltd.), then dried and calendered to give the base paper having a regulated density of 1.05 g/cm³. This product was designated support A.

### Example 1

Preparation of an Ink-Receiving Layer Coating Solution B1

The respective components in the following formulation were added gradually under stirring in the order from the uppermost component, to prepare the ink-receiving layer coating solution B1.

Composition of the ink-receiving layer image-receiving coating solution B1

Acryl styrene compound dispersion (penetration hole particles)

(trade name: MUTICLE PP2000TX, manufactured by Mitsui Chemicals, Inc.; average particle diameter, 0.5 μm; Tg, 105° C.; solid content, 20%) 100 parts

Polyoxyethylene lauryl ether

(trade name: EMULGEN 109P, manufactured by Kao Corporation; HLB value, 13.6; solids content, 10% aqueous solution) 1 part

Acrylic compound emulsion

(trade name: LICABOND ES-90, manufactured by Chuo Rika Kogyo; Tg, 108° C.; solids content, 50%) 40 parts

Acrylic compound emulsion

(trade name: VINYBRON 2642, manufactured by Nisshin Chemicals Co., Ltd.; Tg, −34° C.; solids content, 40%) 5 parts

Preparation of an Ink Jet Recording Image-Receiving Material

The obverse of support A was coated, in a coating amount of 35 g/m², with the ink-receiving layer coating solution B1 by a hopper applicator and then dried at 50° C. with a hot-air dryer. An ink jet recording image-receiving layer in Example 1 was thus prepared.

The content of the thermoplastic component in the ink-receiving layer was 99.8 mass % based on the total solid content of the ink-receiving layer, and the content of the penetration hole particles was 47.5 mass % based on the total solid content of the ink-receiving layer.

### Example 2

An ink jet recording image-receiving material in Example 2 was prepared in the same manner as in Example 1 except that the following ink-receiving layer coating solution B2 was used in place of the ink-receiving layer coating solution B1 in preparation of the ink jet recording image-receiving material in Example 1.

The content of the thermoplastic component in the ink-receiving layer was 99.9 mass % based on the total solid content of the ink-receiving layer, and the content of the particles having concaves was 47.6 mass % based on the total solid content of the ink-receiving layer.

Preparation of the Ink-Receiving Layer Coating Solution B2

The respective components in the following formulation were added gradually under stirring in the order from the uppermost component, to prepare the ink-receiving layer coating solution.

Composition of the Ink-Receiving Layer Coating Solution B2

| | |
|---|---|
| Acrylic compound dispersion (penetration hole particles) | 45.5 parts |
| (trade name: MUTICLE PP240D, manufactured by Mitsui | |
| Chemicals, Inc.; solid content, 44%; average particle | |
| diameter, 0.5 μm; Tg, 105° C.) | |
| Polyoxyethylene lauryl ether | 0.5 parts |
| (trade name: EMULGEN 109P, manufactured by Kao | |
| Corporation; HLB value, 13.6; solid content, 10% aqueous | |
| solution) | |
| Acrylic compound emulsion | 40 parts |
| (trade name: LICABOND ES-90, manufactured by Chuo Rika | |
| Kogyo; solid content, 50%; Tg, 108° C.) | |
| Acrylic compound emulsion | 5 parts |
| (trade name: VINYBRON 2642, manufactured by Nisshin | |
| Chemicals Co., Ltd.; Tg, −34° C.; solids content, 40%) | |

### Example 3

An ink jet recording image-receiving material in Example 3 was prepared in the same manner as in Example 1 except that the following ink-receiving layer coating solution B3 was used in place of the ink-receiving layer coating solution B1 in preparation of the ink jet recording image-receiving material in Example 1. The content of the thermoplastic component in the ink-receiving layer was 99.8 mass % based on the total solids content of the ink-receiving layer, and the content of the penetration hole particles was 47.5 mass % based on the total solids content of the ink-receiving layer.

Preparation of the Ink-Receiving Layer Coating Solution B3

The respective components in the following formulation were added gradually under stirring in the order from the uppermost component, to prepare the ink-receiving layer coating solution.

Composition of the Ink-Receiving Layer Coating Solution B3

| | |
|---|---|
| Acryl styrene compound dispersion (penetration hole | 100 parts |
| particles) (trade name: MUTICLE PP2000TX, manufactured | |
| by Mitsui Chemicals, Inc.; average particle diameter, | |
| 0.5 μm; Tg, 105° C.; solid content, 20%) | |
| Polyoxyethylene lauryl ether | 1 part |
| (trade name: EMULGEN 109P, manufactured by Kao | |
| Corporation; HLB value, 13.6; solid content, | |
| 10% aqueous solution) | |
| Acrylic compound emulsion | 40 parts |
| (trade name: LICABOND ES-90, manufactured by Chuo | |
| Rika Kogyo; Tg, 108° C.; solid content, 50%) | |
| Acrylic compound emulsion | 4 parts |
| (trade name: LICABOND ET-111, manufactured by Chuo | |
| Rika Kogyo; Tg, −11° C.; solid content, 50%) | |

### Example 4

An ink jet recording image-receiving material in Example 4 was prepared in the same manner as in Example 1 except that the following ink-receiving layer coating solution B4 was used in place of the ink-receiving layer coating solution B1 in preparation of the ink jet recording image-receiving material in Example 1. The content of the thermoplastic component in the ink-receiving layer was 95.2% based on the total solid content of the ink-receiving layer, and the content of the penetration hole particles was 45.8% based on the total solid content of the ink-receiving layer.

Preparation of the Ink-Receiving Layer Coating Solution B4

The respective components in the following formulation were added gradually under stirring from the uppermost component, to prepare the ink-receiving layer coating solution.

Composition of the Ink-Receiving Layer Coating Solution

| | |
|---|---|
| Acryl styrene compound dispersion (penetration hole | 100 parts |
| particles) (trade name: MUTICLE PP2000TX, manufactured | |
| by Mitsui Chemicals, Inc.; average particle diameter, | |
| 0.5 μm; Tg, 105° C.; solid content, 20%) | |
| Polyoxyethylene lauryl ether | 1 part |
| (trade name: EMULGEN 109P, manufactured by Kao | |
| Corporation; HLB value, 13.6; solid content, 10% aqueous | |
| solution) | |
| Acrylic compound emulsion | 40 parts |
| (trade name: VONCOAT SK-105, manufactured by DIC; Tg, | |
| 100° C.; solid content, 54%) | |
| Aqueous PVA solution (trade name: PVA205, manufactured | 20 parts |
| by Toray; solids content, 10 mass %) | |

### Example 5

An ink jet recording image-receiving material in Example 5 was prepared in the same manner as in Example 1 except that the following ink-receiving layer coating solution B5 was used in place of the ink-receiving layer coating solution B1 in preparation of the ink jet recording image-receiving material in Example 1. The content of the thermoplastic component in the ink-receiving layer was 99.6 mass % based on the total solid content of the ink-receiving layer, and the content of the penetration hole particles was 83.0 mass % based on the total solid content of the ink-receiving layer.

Preparation of the Ink-Receiving Layer Coating Solution B5

The respective components in the following formulation were added gradually under stirring in the order from the uppermost component, to prepare the ink-receiving layer coating solution.

Composition of the Ink-Receiving Layer Coating Solution

| | |
|---|---|
| Acryl styrene compound dispersion (penetration hole | 100 parts |
| particles) (trade name: MUTICLE PP2000TX, manufactured | |
| by Mitsui Chemicals, Inc.; average particle diameter, | |
| 0.5 μm; Tg, 105° C.; solid content, 20%) | |
| Polyoxyethylene lauryl ether | 1 part |
| (trade name: EMULGEN 109P, manufactured by Kao | |
| Corporation; HLB value, 13.6; solid content, 10% aqueous | |
| solution) | |
| Low-density polyethylene fine particle dispersion | 10 parts |
| (trade name: CHEMIPEARL M200, manufactured by Mitsui | |
| Chemicals, Inc.; average particle diameter 6 μm, 40%) | |

### Example 6

An ink jet recording image-receiving material in Example 6 was prepared in the same manner as in Example 1 except that the following ink-receiving layer coating solution B6 was used in place of the ink-receiving layer coating solution B1 in preparation of the ink jet recording image-receiving material in Example 1. The ink-receiving layer shows thermoplasticity by the presence of the following penetration hole particles. The content of the thermoplastic component in the ink-receiving layer was 99.9 mass % based on the total solid content of the ink-receiving layer, and the content of the penetration hole particles was 91.7 mass % based on the total solid content of the ink-receiving layer.

Preparation of the Ink-Receiving Layer Coating Solution B6

The respective components in the following formulation were added gradually under stirring in the order from the uppermost component, to prepare the ink-receiving layer coating solution.

Composition of the Ink-Receiving Layer Coating Solution

| | |
|---|---|
| Acryl styrene compound dispersion (penetration hole | 100 parts |
| particles) (trade name: MUTICLE PP2000TX, manufactured | |
| by Mitsui Chemicals, Inc.; average particle diameter, | |
| 0.5 μm; Tg, 105° C.; solid content, 20%) | |
| Aqueous PVA solution (trade name: PVA205, manufactured | 10 parts |
| by Kuraray; solid content, 10%) | |
| TEGmBE (diethylene glycol monobutyl ether) | 0.8 parts |

### Comparative Example 1

An ink jet recording image-receiving material in Comparative Example 1 was prepared in the same manner as in Example 3 except that MUTICLE PP2000TX (described above) was not added, and the amount of EMULGEN 109P (described above) was 0.3 parts. The content of the thermoplastic component in the ink-receiving layer was 99.9 mass % based on the total solid content of the ink-receiving layer.

### Comparative Example 2

An ink jet recording image-receiving material in Comparative Example 2 was prepared in the same manner as in Example 4 except that MUTICLE PP2000TX (described above) was not added, EMULGEN 109P (described above) was added in an amount of 0.3 parts, and deionized water was added in an amount of 20 parts. The content of the thermoplastic component in the ink-receiving layer was 91.4 mass % based on the total solid content of the ink-receiving layer.

### Comparative Example 3

An ink jet recording image-receiving material in Comparative Example 3 was prepared in the same manner as in Example 5 except that MUTICLE PP2000TX (described above) was not added, EMULGEN 109P (described above) was added in an amount of 0.3 parts, and deionized water was added in an amount of 20 parts. The content of the thermoplastic component in the ink-receiving layer was 99.3 mass % based on the total solid content of the ink-receiving layer.

Dispersed ink A

Preparation of Colored Fine Particle Dispersion D-1

0.6 parts of the following oil-soluble dye (a), 1.4 parts of an oil-soluble polymer (butyl acrylate/methyl methacrylate copolymer [copolymerization ratio (molar ratio)=50/50]), and 0.3 parts of the following compound (B-1) were mixed with 10 parts of ethyl acetate to give solution I (organic phase). Separately, 0.3 parts of sodium di(2-ethylhexyl)sulfosuccinate was added to 15 parts of water to give solution II (aqueous phase).

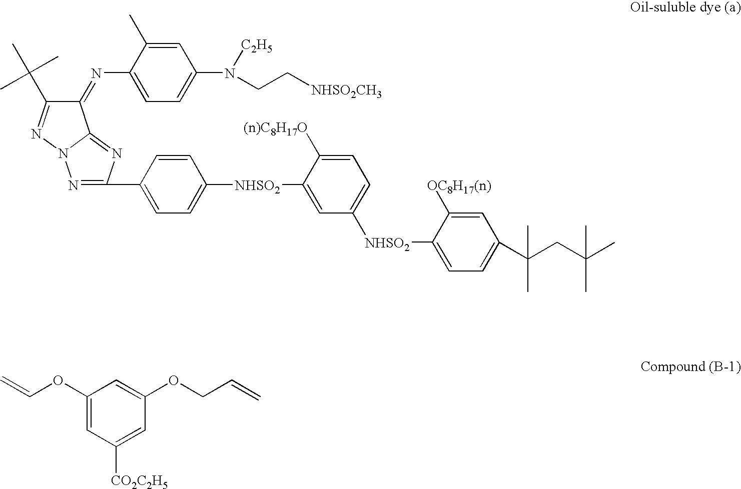

The solution I was added to the solution II, and the mixture was emulsified and dispersed with a homogenizer, and 1 part of water-soluble polymer (c-1) below was added thereto and stirred under reduced pressure, to remove the solvent ethyl acetate, whereby colored fine particle dispersion D-1 with a solid content of 10% was obtained. The particle diameter of the dispersed droplets (organic phase) in the colored fine particle dispersion D-1, as determined by a particle size distribution measuring instrument LB-500 manufactured by Horiba, Ltd., was 85 nm in terms of volume-average particle diameter.

Water-Soluble Polymer (c-1) 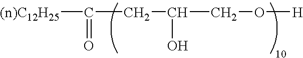
Preparation of Dispersed Ink A

The resulting colored fine particle dispersion D-1 was used as shown in the following composition, and the components in the composition were mixed and filtered through a 0.45 μm filter to give dispersed ink A.

| | |
|---|---|
| The colored fine particle dispersion (D-1) | 60 parts |
| Diethylene glycol | 5 parts |
| Glycerin | 15 parts |
| Diethanol amine | 1 part |
| Polyethylene glycol | 1 part |
| Water | amount to adjust the total to |
| | 100 parts |

Dispersed Ink B
Preparation of Colored Fine Particle Dispersion D-2

In preparation of the dispersed ink A, compound (B-1) was not added, 2 parts of EMAL 20C (25%) were used in place of 0.3 parts of sodium di(2-ethylhexyl)sulfosuccinate, and the mixture was emulsified and dispersed, and without adding the water-soluble polymer (c-1), the solvent was removed under reduced pressure, and the mixture was regulated to a solid content of 10%, to give colored fine particle dispersion D-2. The particle diameter of the dispersed droplets (organic phase) in the colored fine particle dispersion D-2, as determined in the same manner as for the colored fine particle dispersion D-2, was 95 nm in terms of volume-average particle diameter.

Preparation of Dispersed Ink B

Dispersed ink B was prepared in the same manner as in “preparation of dispersed ink A” described above except that the resulting colored fine particle dispersion D-2 was used.

Evaluation Test

The ink jet recording image-receiving materials in Examples 1 to 6 and the ink jet recording image-receiving materials in Comparative Examples 1 to 3 were examined in the following evaluation test. The results are shown in Table 1.
(1) Average Pore Diameter (Measurement of the Average Pore Diameter of the Ink-Receiving Layer)

Photographs of the surface of the ink jet recording image-receiving materials taken with a scanning electron microscope (SEM) (magnification from ×10,000 to ×100,000) were input to a scanner, digitized and subjected to image processing with a computer, and the average (number-average) diameter in distribution of the diameters of circles equal in area to the respective extracted voids was determined and expressed as the average pore diameter of the ink-receiving layer.
(2) Ink Permeability

The permeability of dispersed ink A into the ink jet recording image-receiving material was evaluated in the following manner.

The permeability was evaluated from incline Ka (ml/m²·s^{1/2}) determined by plotting the amount of liquid absorbed (amount of dispersed ink A transferred) against the square root ((ms)^{1/2}) of contact time determined by a liquid absorption testing method according to the Bristow method described in J. TAPPI Nos. 51-87. A larger incline Ka indicates higher permeability.
(3) Image Vividness

1) After a printer (trade name: PX-V700, manufactured by EPSON) was charged with dispersed ink A and dispersed ink B and used in printing (“Evaluation 1” and “Evaluation 2”, respectively), and 2) after printers (trade names: PM-G800 and PM-G900, manufactured by EPSON) were used in printing (“Evaluation 3” and “Evaluation 4”, respectively), each print sample was subjected to smoothing treatment with heating rolls (surface temperature of the metal rolls: 150° C.) shown in FIG. 1.

Then, each print sample consisting of alphabetical letters and characters (Chinese characters) was observed by 10 persons consisting of 5 men and 5 women, and evaluated visually. In the visual evaluation, the following evaluation points by the respective persons were summed up and evaluated according to the following evaluation criteria. The results are shown in Table 1.

Evaluation Point:

3: Vivid image with a sharp edge.

2: Image with a slightly blurred edge.

1: Image with feathering and bleeding.

Evaluation Criteria:

A: Total points of 25 or higher.

B: Total points of 20 to 25.

C: Total points lower than 20.

TABLE 1

| | Content of | Content of penetration | Average | Ka | | | | |
|---|---|---|---|---|---|---|---|---|
| | Thermoplastic | hole particles or | pore | (ml/ | Image vividness | | | |
| | Component | particles having | diameter | m² · | Evalua- | Evalua- | Evalua- | Evalua- |
| | (mass %) | concaves (mass %) | (μm) | s^{1/2}) | tion 1 | tion 2 | tion 3 | tion 4 |
| Example 1 | 99.8 | 47.5 | 1.1 | 119 | A | A | A | A |
| Example 2 | 99.9 | 47.6 | 0.8 | 78 | A | A | A | A |
| Example 3 | 99.8 | 47.5 | 0.3 | 56 | A | A | A | A |
| Example 4 | 95.2 | 45.8 | 0.2 | 30 | A | A | A | A |
| Example 5 | 99.6 | 83.0 | 0.3 | 35 | A | A | A | A |
| Example 6 | 99.9 | 91.7 | 1.2 | 135 | A | A | A | A |
| Comparative | 99.9 | 0 | 0.09 | 10.6 | C | C | C | C |
| Example 1 | | | | | | | | |
| Comparative | 91.4 | 0 | 0.03 or | 3.4 | C | C | C | C |
| Example 2 | | | less | | | | | |
| Comparative | 99.3 | 0 | 0.03 or | 55 | C | C | C | C |
| Example 3 | | | less | | | | | |

As can be seen from Table 1, the ink jet recording image-receiving materials containing penetration particles in the ink-receiving layer (porous layer) in Example 1 to 6 are excellent in permeability with ink, with the ink-receiving layer having an average pore diameter of 0.1 μm or more, and can give excellent results in respect of image vividness. On the other hand, the ink jet recording image-receiving materials in Comparative Examples 1 to 3 wherein the average pore diameter of the ink-receiving layer is 0.1 μm or less are inferior in permeability with ink and image vividness.

1. An image-receiving material having a support and an ink-receiving layer formed on the support, wherein the ink-receiving layer contains at least one of the groups consisting of: particles having penetration holes; and particles having concaves, in an amount of at least 10 mass % based on the total solid content of the ink-receiving layer, the ink-receiving layer has thermoplasticity, and the ink-receiving layer contains a thermoplastic component which generates the thermoplasticity in an amount of at least 50 mass % based on the total solid content of the ink-receiving layer.

2. The image-receiving material according to claim 1, wherein the particles having penetration holes are contained therein, and the particles are organic particles.

3. The image-receiving material according to claim 2, wherein the particles are particles containing at least one of a styrene compound and an acrylic compound.

4. The image-receiving material according to claim 1, wherein the particles having concaves are contained therein, and the particles are erythrocyte-shaped flat particles.

5. The image-receiving material according to claim 2, wherein the particles having concaves are contained therein, and the particles are erythrocyte-shaped flat particles.

6. The image-receiving material according to claim 3, wherein the particles having concaves are contained therein, and the particles are erythrocyte-shaped flat particles.

7. The image-receiving material according to claim 1, wherein the ink-receiving layer contains thermoplastic fine particles.

8. The image-receiving material according to claim 1, wherein the ink-receiving layer contains a thermoplastic water-soluble polymer.

9. The image-receiving material according to claim 1, wherein the ink-receiving layer is a porous layer, an average pore diameter of which is 0.1 μm or more.

10. The image-receiving material according to claim 1, wherein the thermoplastic component of the ink-receiving layer is at least one member selected from organic particles, thermoplastic fine particles and a thermoplastic water-soluble polymer, and Tg of at least one member selected from the organic particles, the thermoplastic fine particles and the thermoplastic water-soluble polymer contained as the thermoplastic component is 150° C. or less.

11. The image-receiving material according to claim 1, wherein the image-receiving material is used for ink jet recording.

12. An ink jet recording method comprising:
recording on an image-receiving material with at least one of dispersed ink, pigment ink, water-soluble dye ink, photo-curable ink and solvent ink, and
subjecting the image-receiving material after recording to smoothing treatment, wherein the image-receiving material has a support and an ink-receiving layer formed on the support, and wherein the ink-receiving layer contains at least one of the groups consisting of: particles having penetration holes; and particles having concaves, in an amount of at least 10 mass % based on the total solid content of the ink-receiving layer, the ink-receiving layer has thermoplasticity, and the ink-receiving layer contains a thermoplastic component which generates the thermoplasticity in an amount of at least 50 mass % based on the total solid content of the ink-receiving layer.

13. The ink jet recording method according to claim 12, wherein the particles having penetration holes are contained therein, and the particles are organic particles.

14. The ink jet recording method according to claim 13, wherein the particles are particles containing at least one of a styrene compound and an acrylic compound.

15. The ink jet recording method according to claim 12, wherein the particles having concaves are contained therein, and the particles are erythrocyte-shaped flat particles.

16. The ink jet recording method according to claim 13, wherein the particles having concaves are contained therein, and the particles are erythrocyte-shaped flat particles.

17. The ink jet recording method according to claim 14, wherein the particles having concaves are contained therein, and the particles are erythrocyte-shaped flat particles.

18. The ink jet recording method according to claim 12, wherein the ink-receiving layer contains thermoplastic fine particles.

19. The ink jet recording method according to claim 12, wherein the ink-receiving layer contains a thermoplastic water-soluble polymer.

20. The ink jet recording method according to claim 12, wherein the ink-receiving layer is a porous layer, an average pore diameter of which is 0.1 μm or more.
